(19) United States
(12) Patent Application Publication
(10) Pub. No.: US 2026/0333552 A1
(43) Pub. Date: Oct. 22, 2026

(54) LIGHTING CONTROL SYSTEM, TERMINAL DEVICE, LIGHTING CONTROL METHOD, AND RECORDING MEDIUM

(71) Applicant: Panasonic Intellectual Property Management Co., Ltd., Osaka (JP)

(72) Inventors: Kosuke HIRATANI, Osaka (JP); Shintaro HAYASHI, Hyogo (JP); Natsuki KITO, Kyoto (JP); Kentaro YAMAUCHI, Hyogo (JP); Tomohiro YASUDA, Osaka (JP)

(21) Appl. No.: 19/101,457

(22) PCT Filed: Aug. 29, 2023
(86) PCT No.: PCT/JP2023/031322

§ 371 Date: Feb. 5, 2025

(30) Foreign Application Priority Data
Aug. 31, 2022 (JP) 2022-138470
Oct. 28, 2022 (JP) 2022-172969

(51) Int. Cl. H05B 47/175; H05B 45/10

(52) U.S. Cl. CPC H05B 47/198; H05B 45/10; H05B 47/196

(57) ABSTRACT

A lighting control system includes: one or more lighting fixtures that include one or more light emitters; a controller that controls the one or more light emitters; and an acquirer that acquires position information that indicates a predetermined position in a space to be illuminated by the one or more lighting fixtures and a target brightness value of the predetermined position. The one or more light emitters emit illumination light rays that illuminate different regions in the space. The controller determines, based on the target brightness value acquired by the acquirer, a lighting condition for the one or more light emitters, and controls the one or more light emitters based on the lighting condition determined.

### TECHNICAL FIELD

The present invention relates to a lighting control system, a terminal device, a lighting control method, and a program.

### BACKGROUND ART

Patent Literatures (PTLs) 1 and 2 disclose mapping techniques that enable illumination control of a plurality of lighting fixtures. Marks that are associated with the plurality of lighting fixtures are displayed on a display of an operating terminal. The plurality of lighting fixtures can be controlled based on the marks.

PTL 3 discloses a lighting device that uses different lighting methods depending on the location in a lighting space region. The lighting device disclosed in PTL 3 includes a light source for generating illumination light, a light modulation element that modules the light emitted from the light source based on image information, and a projection lens that projects the light modulated by the light modulation element as the illumination light.

### CITATION LIST

### Patent Literature

### [PTL 1]

Japanese Unexamined Patent Application Publication No. 2019-155334

### [PTL 2]

Japanese Unexamined Patent Application Publication No. 2019-36400

### [PTL 3]

Japanese Unexamined Patent Application Publication No. 2015-72416

### SUMMARY OF INVENTION

### Technical Problem

There is a demand to illuminate a specific location such as the vicinity of a desk or a chair by a user performing lighting control. In order to satisfy this demand, the above-described conventional techniques enable control of the lighting fixtures by a user specifying a lighting fixture that illuminates a specific location from among the plurality of lighting fixtures, and selecting a mark that corresponds to the specified lighting fixture from among the marks that are associated with the lighting fixtures.

However, the location where the user wants to illuminate and the actual lighting fixture for illuminating the location are not clearly associated with each other, which may cause the user to specify a wrong lighting fixture, making it difficult for the user to intuitively operate. As described above, the above-described conventional techniques are problematic in that the level of user convenience is low.

To address this, it is an object of the present invention to provide a lighting control system, a terminal device, a lighting control method, and a program that can provide a high level of user convenience.

### Solution to Problem

A lighting control system according to one aspect of the present invention includes: one or more lighting fixtures, each including one or more light emitters; a controller that controls the one or more light emitters; and an acquirer that acquires position information that indicates a predetermined position in a space to be illuminated by the one or more lighting fixtures and a target brightness value of the predetermined position, wherein the one or more light emitters emit illumination light rays that illuminate different regions in the space, and the controller determines, based on the target brightness value acquired by the acquirer, a lighting condition for the one or more light emitters, and controls the one or more light emitters based on the lighting condition determined.

A terminal device according to one aspect of the present invention includes: a controller that controls one or more light emitters included in one or more lighting fixtures; a user interface that receives an operation input from a user; and an acquirer that acquires position information that indicates a predetermined position in a space to be illuminated by the one or more lighting fixtures based on the operation input received by the user interface and a target brightness value of the predetermined position, wherein the one or more light emitters emit illumination light rays that illuminate different regions in the space, and the controller determines a lighting condition for the one or more light emitters based on the target brightness value acquired by the acquirer, and controls the one or more light emitters based on the lighting condition determined.

A lighting control method according to one aspect of the present invention includes: controlling one or more light emitters included in one or more lighting fixtures; and acquiring position information that indicates a predetermined position in a space to be illuminated by the one or more lighting fixtures and a target brightness value of the predetermined position, wherein the one or more light emitters emit illumination light rays that illuminate different regions in the space, and the controlling includes: determining a lighting condition for the one or more light emitters based on the target brightness value acquired; and controlling the one or more light emitters based on the lighting condition determined.

Also, one aspect of the present invention can be implemented as a program for causing a computer to execute the above-described lighting control method, or as a computer-readable non-transitory recording medium having recorded thereon the program.

### Advantageous Effects of Invention

According to the present invention, it is possible to provide a lighting control system, a terminal device, a lighting control method, and a program that can provide a high level of user convenience.

### BRIEF DESCRIPTION OF DRAWINGS

FIG. 1 is a block diagram of a lighting control system according to Embodiment 1.

FIG. 2 is a plan view showing an example of a layout of a lighting space to be illuminated by the lighting control system according to Embodiment 1.

FIG. 3 is a plan view illustrating a relationship between a plurality of light emitting elements included in a lighting fixture and lighting regions according to Embodiment 1.

FIG. 4 is a diagram showing an example of an operation screen displayed on a terminal device included in the lighting control system according to Embodiment 1.

FIG. 5 is a diagram illustrating an operation performed on a field shown on the operation screen shown in FIG. 4.

FIG. 6 is a diagram showing another example of an operation screen displayed on the terminal device included in the lighting control system according to Embodiment 1.

FIG. 7 is a diagram showing another example of an operation screen displayed on the terminal device included in the lighting control system according to Embodiment 1.

FIG. 8 is a diagram showing another example of an operation screen displayed on the terminal device included in the lighting control system according to Embodiment 1.

FIG. 9 is a diagram showing another example of an operation screen displayed on the terminal device included in the lighting control system according to Embodiment 1.

FIG. 10 is a diagram showing another example of an operation screen displayed on the terminal device included in the lighting control system according to Embodiment 1.

FIG. 11 is a flowchart illustrating an operation performed by the lighting control system according to Embodiment 1.

FIG. 12 is a diagram showing a usage state of a lighting system according to Embodiment 2.

FIG. 13 is a block diagram showing a configuration of the lighting system according to Embodiment 2.

FIG. 14 is a schematic perspective view of the lighting system according to Embodiment 2.

FIG. 15A is a diagram showing an example of correspondence information stored in a storage included in the lighting system according to Embodiment 2.

FIG. 15B is a diagram showing an example of correspondence information stored in the storage included in the lighting system according to Embodiment 2.

FIG. 16 is a flowchart illustrating an operation performed by the lighting system according to Embodiment 2.

FIG. 17 is a flowchart illustrating lighting target surface specifying processing included in the operation performed by the lighting system according to Embodiment 2.

FIG. 18 is a block diagram showing a configuration of a lighting device according to Variation 1.

FIG. 19 is a block diagram showing a lighting system according to Variation 2.

### DESCRIPTION OF EMBODIMENTS

Hereinafter, a lighting control system, a terminal device, a lighting control method, a lighting device, a lighting system, a lighting device control method, and the like according to embodiments of the present invention will be described in detail with reference to the accompanying drawings. The embodiments described below are merely specific examples of the present invention. Accordingly, the numerical values, shapes, materials, structural elements, the arrangement and connection of the structural elements, steps, the order of the steps, and the like shown in the following embodiments are merely examples, and therefore are not intended to limit the scope of the present invention. Accordingly, among the structural elements described in the following embodiments, structural elements not recited in any one of the independent claims are described as arbitrary structural elements.

Also, the diagrams are schematic representations, and thus are not necessarily true to scale. Accordingly, for example, the scaling and the like are not necessary the same in the diagrams. Also, in the diagrams, structural elements that are substantially the same are given the same reference numerals, and a redundant description is omitted or simplified.

Also, in the specification of the present application, the terms that describe the relationship between elements, the terms that describe the shape of elements such as “rectangle” and “circle”, and numerical value ranges are expressions that not only have a strict meaning but also encompass a substantially equal range, for example, a margin of about several percent.

Also, in the specification of the present application, unless otherwise stated, ordinal numbers such as “first” and “second” do not mean the number or order of structural elements, and are used to avoid confusion of the same type of structural elements and make a distinction between the same type of structural elements.

### Embodiment 1

### Overview of Lighting Control System

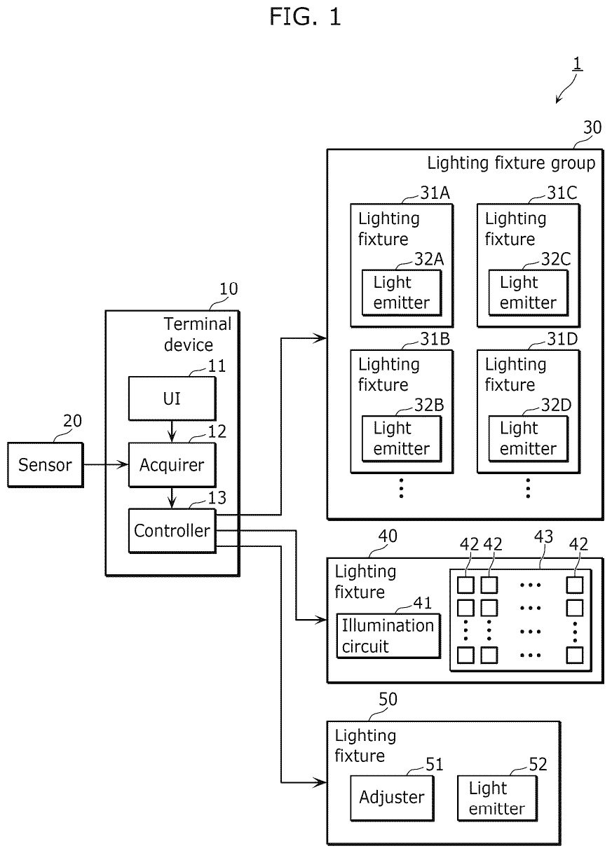

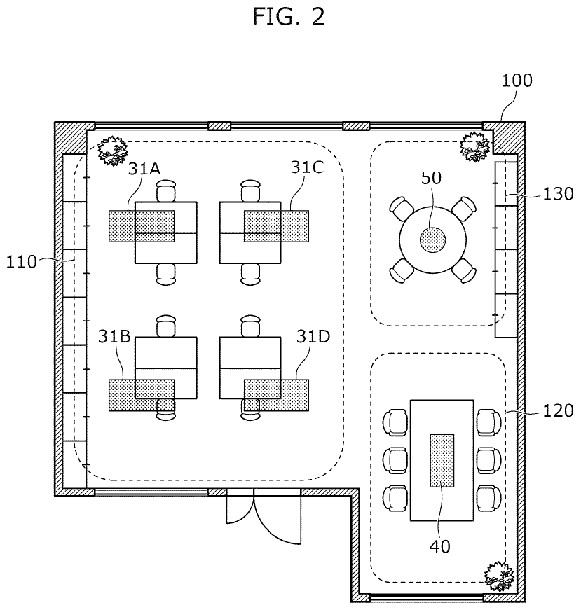

An overview of a lighting control system according to the present embodiment will be described with reference to FIGS. 1 and 2.

FIG. 1 is a block diagram showing a configuration of lighting control system 1 according to the present embodiment. FIG. 2 is a plan view showing an example of a layout of lighting space 100 to be illuminated by lighting control system 1 according to the present embodiment.

Lighting control system 1 shown in FIG. 1 is a system that controls the lighting mode of lighting space 100 shown in FIG. 2. Lighting space 100 is a space to be illuminated by one or more lighting fixtures, and may be, for example, an indoor space such as a room in a building. Lighting fixture group 30 and lighting fixtures 40 and 50 are fixed to the ceiling, a wall, or the like of lighting space 100.

Lighting fixture group 30, lighting fixture 40, and lighting fixture 50 can illuminate different areas. For example, lighting fixture group 30 can illuminate first area 110. Lighting fixture 40 can illuminate second area 120. Lighting fixture 50 can illuminate third area 130. First area 110, second area 120, and third area 130 may partially overlap each other.

Each of lighting fixture group 30, lighting fixture 40, and lighting fixture 50 includes a plurality of light emitters. As a result of the plurality of light emitters being controlled independently, it is possible to illuminate only a predetermined range in each of first area 110, second area 120, and third area 130. For example, it is possible to locally create a bright location and a dark location in each area.

In the present embodiment, each of lighting fixture group 30, lighting fixture 40, and lighting fixture 50 can be controlled based on an operation input from a user via UI 11 included in terminal device 10 and/or a result of detection performed by sensor 20. For example, when the user wants to light up a desired area range, it is only necessary for the user to simply make settings such as setting the desired area range and the target brightness value of the desired area range via UI 11 of terminal device 10, without the user having to specifically specify a lighting fixture for illuminating the desired area range. Lighting control system 1 automatically illuminates the user's desired area range based on the operation input from the user. Also, lighting control system 1 can also automatically illuminate based on a result of detection performed by sensor 20, even without the user's settings.

As described above, according to the present embodiment, it is possible to implement lighting control system 1, terminal device 10, a lighting control method, and the like that can provide a high level of user convenience. When the level of user convenience is high, the user's operations can be processed promptly and easily as requested. Accordingly, it is expected that the number of redo operations and the operation time can be reduced, and thus the consumption energy of lighting control system 1 can be reduced. Hereinafter, specific structural elements that constitute lighting control system 1 will be described in detail.

### Configuration

As shown in FIG. 1, lighting control system 1 includes terminal device 10, sensor 20, lighting fixture group 30, and lighting fixtures 40 and 50.

Terminal device 10 is a control device that performs lighting control on lighting fixture group 30 and lighting fixtures 40 and 50. The lighting control not only includes light illumination (on) control and light extinction (off) control, but also includes control on illumination light such as adjusting the illumination intensity, adjusting the illumination color, and changing the lighting region (lighting range). In the present embodiment, terminal device 10 performs lighting control based on an operation input from the user and/or a result of detection performed by sensor 20. Terminal device 10 is connected to sensor 20, lighting fixture group 30, and lighting fixtures 40 and 50 so as to be capable of performing communication with each other via a network. The communication can be wireless or wired communication.

Terminal device 10 is, for example, a mobile terminal such as a smartphone or a tablet terminal. Alternatively, terminal device 10 may be an operating terminal fixed to a wall or the like of lighting space 100, a stationary computer, or the like.

As shown in FIG. 1, terminal device 10 includes UI (user interface) 11, acquirer 12, and controller 13.

UI 11 receives an operation input from the user. Specifically, UI 11 includes a display that can display an operation screen on which the user can perform an operation. The display is a touch panel display that can perform both operations of receiving an operation input from the user and displaying an operation screen. Alternatively, UI 11 may include a display for display purpose only and an input device such as a keyboard, a mouse, or a microphone. A specific example of the operation screen will be described later.

Acquirer 12 acquires position information that indicates a predetermined position in lighting space 100 and a target brightness value of the predetermined position. For example, acquirer 12 may acquire position information that indicates a plurality of positions including the predetermined position and target brightness values of the plurality of positions. The plurality of positions are, for example, positions that are spaced apart from each other. Also, acquirer 12 further acquires a target value for at least one of a size, a shape, or a color of a lighting region for illuminating the predetermined position. Acquirer 12 may acquire a target value for size, shape, or color of each of a plurality of lighting regions for illuminating each of the plurality of positions including the predetermined position.

Brightness is expressed by, for example, illuminance. Alternatively, brightness may be expressed by luminous intensity. Color is expressed by, for example, color temperature. Alternatively, color may be expressed by color information such as RGB.

Each of the plurality of positions may be expressed in a two-dimensional or three-dimensional region. For example, acquirer 12 may acquire target values (a target size value and a target shape value) of a predetermined illumination surface such as the floor or a wall. The plurality of positions may be spatially continuous. That is, acquirer 12 may acquire a target brightness value distribution in lighting space 100 as the target brightness values of the plurality of positions.

In the present embodiment, acquirer 12 acquires a target value based on an operation input received by UI 11. Specifically, acquirer 12 acquires, based on an operation input received by UI 11, position information that indicates a position (predetermined position) selected by the user and a target value for at least one of a brightness, a color, a size, or a shape of the predetermined position. Alternatively, acquirer 12 may determine the predetermined position based on a lighting target object detected by sensor 20. For example, acquirer 12 acquires a target brightness value of the determined predetermined position.

Controller 13 determines, based on the target value acquired by acquirer 12, a lighting condition for one or more light emitters, and controls the one or more light emitters based on the determined lighting condition. Specifically, controller 13 specifies, based on the predetermined position of the target value acquired by acquirer 12, a light emitter to illuminate from among the one or more light emitters, and determines a lighting condition for the specified light emitter. For example, correspondence information that indicates a correspondence relationship between light emitters and lightable regions and are provided to specify a lightable region to be illuminated by one or more light emitters, is stored in a memory (not shown) or the like readable by controller 13. Controller 13 can specify a light emitter for illuminating the predetermined position by referring to the correspondence information read out from the memory.

In the present embodiment, controller 13 generates a brightness distribution in lighting space 100 based on the plurality of target brightness values of the plurality of positions, and determines the lighting condition based on the generated brightness distribution. The lighting condition includes, for example, information that indicates one or more light emitters that emit illumination light for achieving the generated brightness distribution, and light parameters such as light emission intensity, light emission color, light emission direction, and light emission range of the one or more light emitters. The brightness distribution is, specifically, an illuminance distribution, but is not specifically limited thereto as long as a distribution that indicates brightness is used.

The lighting condition is determined for each of lighting fixture group 30, lighting fixture 40, and lighting fixture 50. The lighting condition may be determined for each of lighting fixtures 31A to 31D. The lighting condition is, for example, a brightness distribution lightable by each lighting fixture. Controller 13 generates, based on the determined lighting condition, a control command for each of lighting fixture group 30 and lighting fixtures 40 and 50, and transmits the control commands.

Acquirer 12 and controller 13 are each implemented by, for example, a large scale integration (LSI) that is an integrated circuit (IC). The integrated circuit is not limited to an LSI, and may be a dedicated circuit or a general-purpose processor. For example, acquirer 12 and controller 13 may be one or more microcontrollers. A microcontroller includes, for example, a non-volatile memory in which a program is stored, a volatile memory that is a temporary storage area for executing the program, an input/output port, a processor for executing the program, and the like. Also, acquirer 12 and controller 13 may be a field programmable gate array (FPGA) that can be programmed or a reconfigurable processor that enables reconfiguration of the connection and setting of circuit cells in the LSI. The functions of acquirer 12 and controller 13 may be implemented by software or hardware.

Sensor 20 detects a predetermined lighting target object in lighting space 100. As used herein, the term “lighting target object” refers to an object to be illuminated by illumination light. Sensor 20 detects, from among a plurality of objects present in lighting space 100, an object that satisfies a predetermined condition as the lighting target object. The predetermined condition is set in advance by the user or the like. The lighting target object is, for example, a stationary object. Examples of the stationary object include: furniture such as a desk and a chair; interior decoration items such as a painting and an indoor plant; and the like. Sensor 20 detects the position, the shape, the size, and the like of the lighting target object. Sensor 20 transmits the result of detection to terminal device 10.

Sensor 20 includes, for example, an image sensor and an image processing circuit that processes an image obtained by the image sensor. The image processing circuit detects the position, the shape, the size, and the like of the lighting target object from the image by performing processing such as contour extraction. The processing performed by the image processing circuit may be performed by acquirer 12 or controller 13 of terminal device 10. Sensor 20 may be an object detection sensor that uses infrared rays or ultrasonic waves.

Lighting fixture group 30 includes four lighting fixtures 31A, 31B, 31C, and 31D. The number of lighting fixtures included in lighting fixture group 30 is not limited to four as long as lighting fixture group 30 includes a plurality of lighting fixtures.

The four lighting fixtures 31A, 31B, 31C, and 31D correspond to an example of a plurality of first lighting fixtures, each including only one light emitter. Specifically, lighting fixture 31A includes light emitter 32A. Lighting fixture 31B includes light emitter 32B. Lighting fixture 31C includes light emitter 32C. Lighting fixture 31D includes light emitter 32D. Lighting fixtures 31A to 31D are, for example, downlights, ceiling lights, base lights, or spotlights.

Light emitters 32A to 32D emit illumination light rays for illuminating different regions in lighting space 100. In the present embodiment, for each light emitter, a region (lightable region) that can be illuminated by the light emitter is assigned. Their lightable regions may partially overlap each other. For example, the illumination light rays emitted from light emitters 32A to 32D illuminate different regions in first area 110.

As used herein, the term “the lightable region of a light emitter” refers to a region to which the illumination light emitted from the light emitter can reach. Also, the term “lighting region”, which will be described below, refers to a region to which the illumination light emitted from one or more light emitters reaches. By controlling a lighting condition of each light emitter such as light illumination and light extinction, at least one of a size, a shape, or a color of the lighting region can be adjusted.

Each of light emitters 32A to 32D include a plurality of light emitting elements such as light emitting diodes (LEDs), laser elements, or organic electroluminescent (EL) elements. Light emitters 32A to 32D perform light illumination, light extinction, illumination intensity adjustment, illumination color adjustment, and the like based on a control command transmitted from controller 13.

For example, light emitter 32A includes a blue LED and a yellow phosphor provided on the light emission side of the blue LED. The yellow phosphor is excited by a portion of blue light emitted from the blue LED, and emits yellow light. Light emitter 32A emits white light as mixed light of blue light and yellow light.

Lighting fixture 31A includes an illumination circuit (not shown). The illumination circuit supplies electric power to light emitter 32A to perform light emission control on light emitter 32A. Specifically, the illumination circuit performs, based on a control command transmitted from controller 13, light illumination, light extinction, illumination intensity adjustment, and illumination color adjustment on light emitter 32A. The illumination circuit is implemented by, for example, an application-specific integrated circuit (ASIC). The illumination circuit supplies a pulse-width modulated (PWM) current to each of the plurality of light emitting elements included in light emitter 32A. By adjusting the pulse width of the supplied current, the light emission intensity of light emitter 32A can be changed and the illumination intensity adjustment function can be implemented. There is no particular limitation on the method for illumination intensity adjustment, and amplitude modulation, phase modulation, or the like can be used.

The plurality of light emitting elements included in light emitter 32A may include a plurality of types of light emitting elements that emit white light with different color temperatures. By adjusting the light emission intensity levels of the plurality of types of light emitting elements, light emitter 32A can emit white light with a desired color temperature.

Light emitters 32B to 32D have the same configuration as that of light emitter 32A. Accordingly, each of lighting fixtures 31A to 31D can independently perform light illumination, light extinction, illumination intensity adjustment, and illumination color adjustment.

Each of lighting fixtures 31A to 31D may communicate directly with terminal device 10, or indirectly with terminal device 10 via a control device (not shown) that performs lighting control on lighting fixtures 31A to 31D.

Lighting fixture 40 corresponds to an example of a second lighting fixture, and includes a plurality of light emitters. Specifically, as shown in FIG. 1, lighting fixture 40 includes illumination circuit 41 and array light source 43 that includes a plurality of two-dimensionally arranged light emitting elements 42. The plurality of light emitting elements 42 correspond to a plurality of light emitters.

Illumination circuit 41 performs light emission control on the plurality of light emitting elements 42. Illumination circuit 41 performs, based on a control command transmitted from controller 13, light illumination, light extinction, illumination intensity adjustment, and illumination color adjustment on each of the plurality of light emitting elements 42. Illumination circuit 41 is implemented by, for example, an ASIC. Illumination circuit 41 supplies a PWM modulated current to each of the plurality of light emitting elements 42. By adjusting the pulse width of the supplied current for each light emitting element 42, the light emission intensity of light emitting element 42 can be changed, and the illumination intensity adjustment function can be implemented. There is no particular limitation on the method for illumination intensity adjustment, and amplitude modulation, phase modulation, or the like can be used.

The plurality of light emitting elements 42 are μLEDs. As used herein, the term “μLED” refers to a micro LED with a maximum size of less than 100 μm. The plurality of light emitting elements 42 may be mini LEDs, laser light emitting elements, or organic EL elements. As used herein, the term “mini LED” refers to an LED with a maximum size of 100 μm or more and 200 μm or less. The plurality of light emitting elements 42 may be LEDs with a maximum size greater than 200 μm.

Each of the plurality of light emitting elements 42 emits light due to the electric current supplied from illumination circuit 41. Light emitting element 42 includes, for example, a blue LED and a yellow phosphor provided on the light emission side of the blue LED. The yellow phosphor is excited by a portion of blue light emitted from the blue LED, and emits yellow light. Light emitting element 42 emits white light as mixed light of blue light and yellow light.

The plurality of light emitting elements 42 are mounted on a substrate. The substrate is a rigid substrate, but may be a flexible substrate. A pattern wiring for electrically connecting each of the plurality of light emitting elements 42 to illumination circuit 41 is formed on the substrate.

The plurality of light emitting elements 42 are arranged in a 256×256 array within a planar region of a predetermined size on the substrate. The planar region in which light emitting elements 42 are arranged is, for example, a 3 mm×3 mm rectangular region. The number of light emitting elements 42 and the size of the region in which light emitting elements 42 are arranged are merely an example, and thus are not particularly limited thereto. By arranging a plurality of light emitting elements 42 in a small region, it is possible to achieve miniaturization of a projection lens (not shown) or improve light intake efficiency.

Also, array light source 43 has an illumination intensity adjustment function and an illumination color adjustment function. For example, each of the plurality of light emitting elements 42 can change the light emission intensity according to the amount of electric current supplied from illumination circuit 41. Also, for example, the plurality of light emitting elements 42 may include a plurality of types of light emitting elements that emit white light with different color temperatures. By adjusting the light emission intensity levels of the plurality of types of light emitting elements, array light source 43 can emit white light with a desired color temperature.

The plurality of light emitting elements 42 may include a red LED that emits red light, a green LED that emits green light, and a blue LED that emits blue light. With this configuration, array light source 43 can also emit color lights other than white light.

Lighting fixture 40 may be a projector that can project an image or the like. Specifically, lighting fixture 40 is a liquid crystal projector or a digital lighting processing (DLP) projector. In this case, each of the plurality of light emitters included in lighting fixture 40 can be regarded as corresponding to an LCD pixel or a micro mirror surface of a digital mirror device (DMD).

Lighting fixture 50 corresponds to an example of a third lighting fixture, and includes an adjuster that adjusts the light emission direction of the illumination light emitted from a light emitter. Specifically, as shown in FIG. 1, lighting fixture 50 includes adjuster 51 and light emitter 52.

Adjuster 51 adjusts the light emission direction of the illumination light emitted from light emitter 52. Adjuster 51 adjusts the light emission direction of the illumination light based on a control command transmitted from controller 13.

Adjuster 51 includes a driving mechanism that can change the orientation of light emitter 52 or the orientation of a projection lens (not shown) that projects the light from light emitter 52. The driving mechanism may change the orientation of entire lighting fixture 50. The driving mechanism is, for example, a stepping motor, an actuator, or the like.

Light emitter 52 has the same configuration as that of light emitter 32A and the like. Also, lighting fixture 50 includes an illumination circuit (not shown). The illumination circuit of lighting fixture 50 has the same configuration as that of the illumination circuit of lighting fixture 31A. With this configuration, light illumination, light extinction, illumination intensity adjustment, and illumination color adjustment are performed on light emitter 52.

In lighting fixture 50, adjuster 51 may also adjust the shape or the size of the lighting region. For example, in the case where lighting fixture 50 includes a projection lens, adjuster 51 may change the size of the lighting region by changing the positional relationship between the projection lens and light emitter 52. Also, for example, lighting fixture 50 may include a light shielding member (not shown) that shields a portion of illumination light emitted from light emitter 52, and adjuster 51 may change the arrangement of the light shielding member. The light shielding member is a member that has an opening of a predetermined shape such as a circular or rectangular opening. The shape or the size of the opening may be changed by a shutter or the like. Adjuster 51 may change the shape or the size of the lighting region by changing the shape or the size of the opening, or changing the position of the light shielding member on or outside an optical path of illumination light.

Lighting fixture 50 may include, instead of light emitter 52, an array light source that has the same configuration as array light source 43 of lighting fixture 40. By adjuster 51 changing the light emission direction of light from the array light source and controlling light illumination, light extinction, illumination intensity adjustment, illumination color adjustment, and the like of each of the plurality of light emitting elements included in the array light source, it is possible to perform precise lighting control.

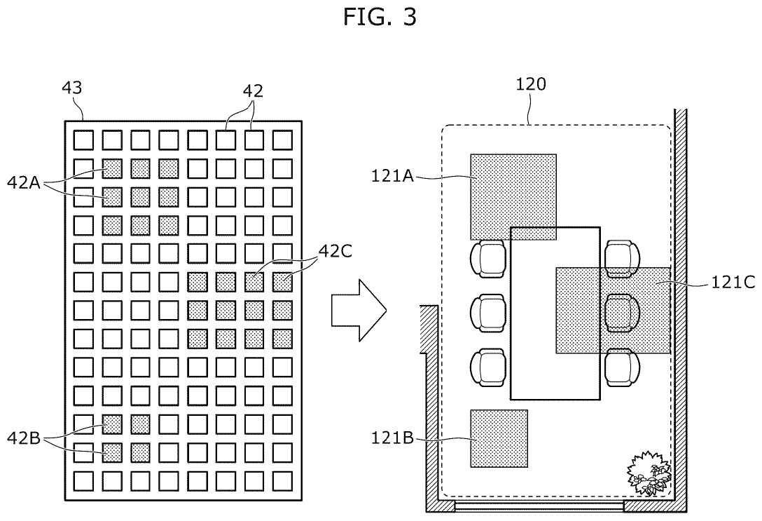

Here, the correspondence relationship between light emitters and lighting regions will be described with reference to FIG. 3. FIG. 3 is a plan view illustrating a relationship between a plurality of light emitting elements 42 included in lighting fixture 40 and lighting regions according to the present embodiment.

FIG. 3 shows an example in which array light source 43 of lighting fixture 40 includes light emitting elements 42 arranged in a two dimensional array of 13 rows×8 columns. Out of these light emitting elements, dotted light emitting elements including 3×3 light emitting elements 42A, 2×2 light emitting elements 42B, and 3×4 light emitting elements 42C are switched on to illuminate.

In lighting fixture 40, light emitting elements 42 and lightable regions are associated in one-to-one correspondence with each other. When a plurality of light emitting elements 42 in a certain range are switched on to illuminate, a lighting region associated with the certain range is illuminated. Specifically, as shown in FIG. 3, in second area 120 to be illuminated by lighting fixture 40, lighting region 121A corresponding to the nine light emitting elements 42A lighting region 121B corresponding to the four light emitting elements 42B, and lighting region 121C corresponding to the twelve light emitting elements 42C are illuminated.

In lighting fixture group 30 as well, there is a correspondence relationship that is similar to that shown in FIG. 3. Specifically, each of the plurality of lighting fixtures 31A to 31D corresponds to one of the plurality of light emitting elements 42 arranged in a two-dimensional array. By performing lighting control on each of lighting fixtures 31A to 31D, the corresponding area can be illuminated.

Also, in the case of lighting fixture 50, by adjuster 51 changing the light emission direction of illumination light, different areas can be illuminated. That is, a plurality of areas can be illuminated by one light emitter 52.

### Operation Screen

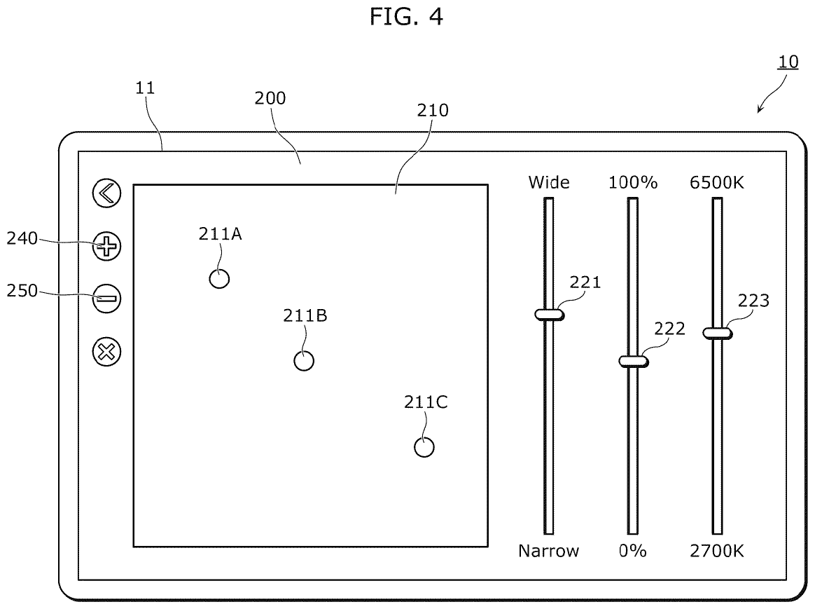

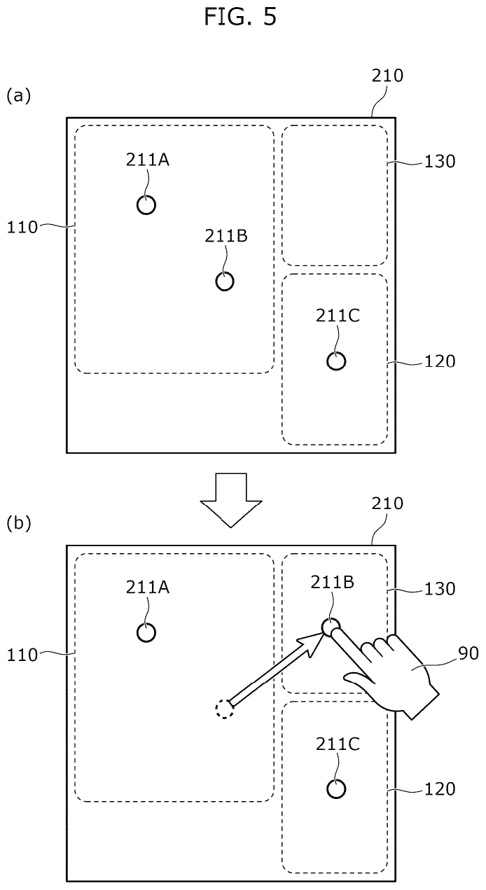

Next, a specific example of an operation screen displayed on the display of UI 11 included in terminal device 10 will be described with reference to FIGS. 4 and 5.

FIG. 4 is a diagram showing an example of an operation screen displayed on terminal device 10 of lighting control system 1 according to the present embodiment. FIG. 5 is a diagram illustrating an operation performed on field 210 shown on operation screen 200 shown in FIG. 4.

Operation screen 200 shown in FIG. 4 includes field 210, size adjustment object 221, brightness adjustment object 222, color adjustment object 223, add button 240, and remove button 250. The structural elements included in operation screen 200 are graphical user interface (GUI) objects that can be operated by the user.

Field 210 is defined in a two-dimensional coordinate system. A set of two-dimensional coordinates in field 210 is associated with a position in lighting space 100. In FIG. 5, for the sake of convenience of description, first area 110, second area 120, and third area 130 of lighting space 100 are shown in field 210. First area 110, second area 120, and third area 130 may be marked by a broken line and displayed on operation screen 200.

Icons 211A, 211B, and 211C shown in FIG. 4 correspond to lighting regions, respectively, and are displayed within field 210. The positions in lighting space 100 that each correspond to a set of two-dimensional coordinates of each of icons 211A, 211B, and 211C in field 210 are to be irradiated with illumination light. For example, in the example shown in (a) in FIG. 5, icons 211A and 211B are located in a range of field 210 that corresponds to first area 110, and thus two positions in first area 110 of lighting space 100 are to be illuminated. Likewise, icon 211C is located at a position near the center of a range that corresponds to second area 120, and thus the position near the center of second area 120 in lighting space 100 is to be illuminated.

The user can select and move each of icons 211A, 211B, and 211C in field 210. For example, as shown in (b) in FIG. 5, the user can select icon 211B using operating element 90 such as the user's finger or a pointer, and move icon 211B by performing a drag operation. In response to the movement of icon 211B, the position of the corresponding lighting region in lighting space 100 is also moved. That is, icon 211B and the actual lighting region in lighting space 100 move in tandem.

Icons 211A, 211B, and 211C are selectable by the user. For example, when icon 211A is selected through a touch operation or a click operation, size adjustment object 221, brightness adjustment object 222, and color adjustment object 223 function as GUI objects for adjusting the size, the brightness, and the color of the lighting region that corresponds to icon 211A.

Size adjustment object 221 is a GUI object for adjusting the size of the lighting region. The size of the lighting region is represented by area, diameter, maximum width, or the like of the lighting region. Size adjustment object 221 is a slider, but the configuration is not limited thereto. Size adjustment object 221 may be a text box that allows the user to directly input a numerical value indicating the size of the lighting region, a list of radio buttons or a dropdown list that allows the user to select from among a plurality of preset options, or the like.

Brightness adjustment object 222 is a GUI object for adjusting the brightness of the lighting region. Brightness adjustment object 222 is a slider, but the configuration is not limited thereto. As with size adjustment object 221, brightness adjustment object 222 may be a text box, a list of radio buttons, a dropdown list, or the like.

Color adjustment object 223 is a GUI object for adjusting the color temperature of the lighting region. Color adjustment object 223 is a slider, but the configuration is not limited thereto. As with size adjustment object 221, color adjustment object 223 may be a text box, a list of radio buttons, a dropdown list, or the like. In the case where lighting fixture group 30 and lighting fixtures 40 and 50 are configured to emit color lights other than white light, color adjustment object 223 may include GUI objects that correspond to RGB colors.

Operation screen 200 may include a shape adjustment object for adjusting the shape of the lighting region. For example, the shape adjustment object may be a list of radio buttons or a dropdown list that allows the user to select a geometric shape such as a circle, an ellipse, a square, a rectangle, or a triangle, or select a number, a letter, or a character. Alternatively, the shape adjustment object may be a text box that allows the user to input a geometric shape, a number, a letter, or a character.

Add button 240 is a GUI object for adding a new icon to field 210. For example, when add button 240 is selected, an icon is added to a predetermined position in field 210. Alternatively, when add button 240 is selected and then a position is selected in field 210, an icon is added to the selected position. In response to the addition of the icon, in lighting space 100, a new lighting region that corresponds to the icon is illuminated.

Remove button 250 is a GUI object for removing an icon in field 210. For example, by selecting an icon in field 210 and then selecting remove button 250, the selected icon is removed. In response to the removal of the icon, in lighting space 100, a lighting region that corresponds to the icon is removed.

The specific display example of operation screen 200 is not limited to the example shown in FIG. 4. The arrangement of the objects can be changed. Also, in operation screen 200, there may be a GUI object that has a function other than those described above, and one or more of the above-described GUI objects may be omitted.

For example, add button 240 and remove button 250 may be omitted. For example, a new icon may be added by simply performing a predetermined operation (for example, a click (touch) operation, a double-click operation, or a hold-down operation) at a location in field 210 where icons 211A, 211B, and 211C are not present. Also, by performing a predetermined operation (a hold-down operation, a right-click operation, or the like) on any one of icons 211A, 211B, or 211C, an option for removing the selected icon (lighting region) may be displayed.

In the present embodiment, the lighting region of the lighting space is changed in response to the user performing an input operation on operation screen 200. Also, when size adjustment object 221 is operated, the size of the corresponding lighting region is changed. The same applies to each of brightness adjustment object 222 and color adjustment object 223.

For example, as shown in (b) in FIG. 5, when icon 211B is moved in field 210, in response to the movement of icon 211B, the position of the corresponding lighting region is also moved. At this time, the position corresponding to icon 211B before it was moved was illuminated by lighting fixture group 30 for illuminating first area 110, but the position corresponding to icon 211B after it has been moved is illuminated by lighting fixture 50 for illuminating third area 130. That is, by the user simply selecting a lighting position in field 210 without having to be aware of the presence of lighting fixtures, the lighting position is automatically illuminated by an appropriate lighting fixture. The user does not have to specify a lighting fixture, which enables highly intuitive lighting control. As described above, lighting control system 1 with a high level of user convenience can be achieved.

### Variation of Operation Screen

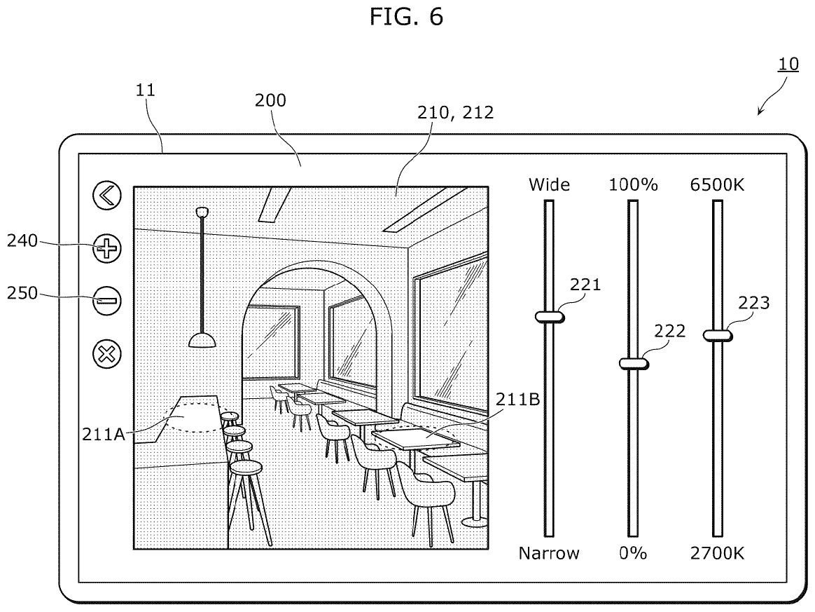

Next, variations of the operation screen will be described with reference to FIGS. 6 to 10.

FIGS. 6 to 10 are diagrams showing other examples of operation screen 200 displayed on terminal device 10 of lighting control system 1 according to the present embodiment.

In operation screen 200 shown in FIG. 6, field 210 includes, as a background image, captured image 212 obtained by capturing lighting space 100. Captured image 212 is an image obtained by capturing lighting space 100 in advance, but captured image 212 is not limited thereto. Captured image 212 may be a real-time image captured using a camera. For example, a captured image of lighting space 100 obtained using a camera (for example, sensor 20) included in terminal device 10 can be used as captured image 212. Captured image 212 may be a moving image.

Icons 211A and 211B are displayed by simply placing the icons on captured image 212, and thus the lighting regions can be identified by simply viewing operation screen 200. Accordingly, more highly intuitive lighting control is possible.

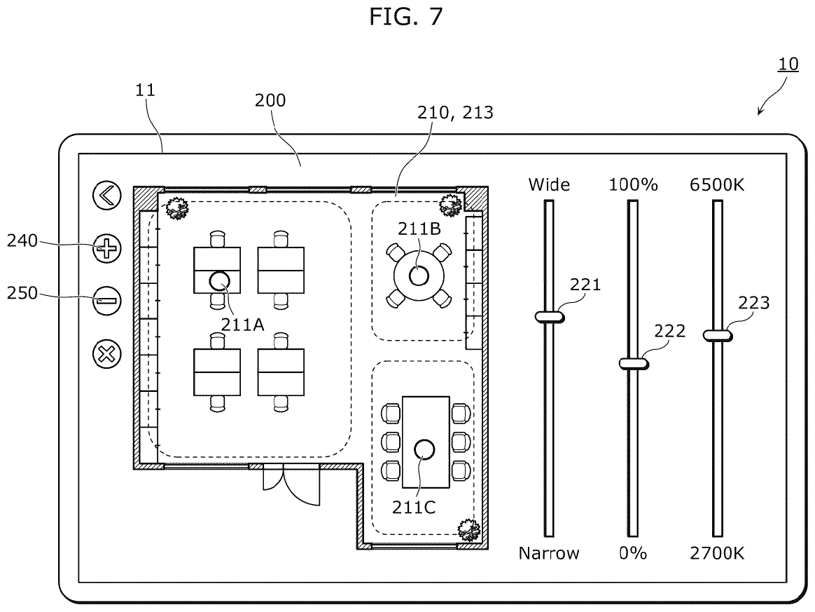

In operation screen 200 shown in FIG. 7, field 210 includes, as a background image, layout image 213 that shows a flat layout of lighting space 100. The layout image is generated based on the design data or the like of lighting space 100, and is stored in, for example, a memory (not shown) included in terminal device 10.

Icons 211A, 211B, and 211C are displayed by simply placing the icons on layout image 213, and thus the lighting regions can be identified by simply viewing operation screen 200. Accordingly, highly intuitive lighting control is possible.

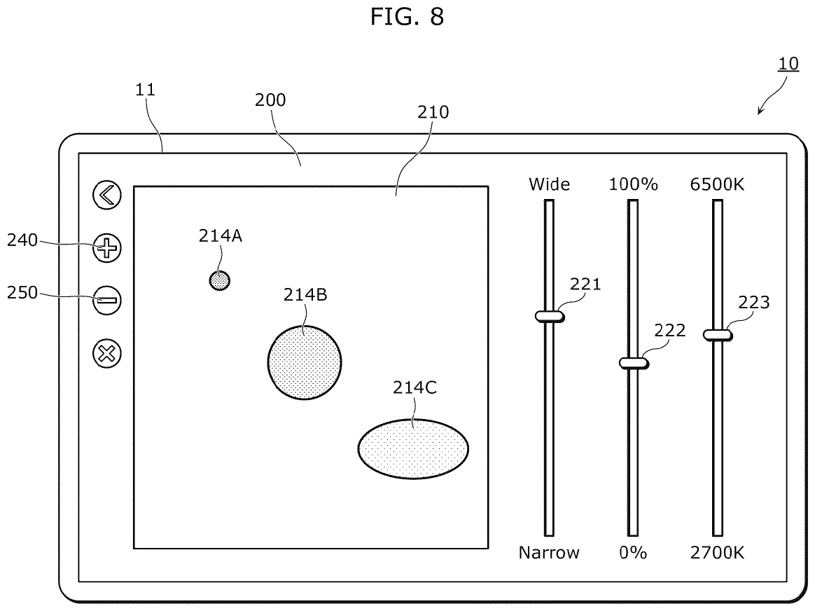

In operation screen 200 shown in FIG. 8, field 210 includes icons 214A, 214B, and 214C. Each of icons 214A, 214B, and 214C represents at least one of a size, a shape, a brightness, or a color of the lighting region. For example, in FIG. 8, icon 214B has a circular shape larger than that of icon 214A. Accordingly, in actual lighting space 100, a lighting region that corresponds to icon 214B has a circular shape and is larger than a lighting region that corresponds to icon 214A. Also, icon 214C has an elliptical shape, and thus a lighting region that corresponds to icon 214C also has an elliptical shape. Also, when icon 214A is displayed brighter than icon 214B, the lighting region that corresponds to icon 214A is illuminated brighter than the lighting region that corresponds to icon 214B. The same applies to the display color of icons 214A, 214B, and 214C. Each of icons 214A, 214B, and 214C represents the color (color temperature) of illumination light that illuminates the lighting region that corresponds to the icon.

As described above, with icons 214A, 214B, and 214C that each represent the actual size, the actual shape, the actual brightness, the actual color, and the like of the corresponding lighting region, the lighting mode of the lighting region can be identified by simply viewing operation screen 200. Accordingly, more highly intuitive lighting control is possible.

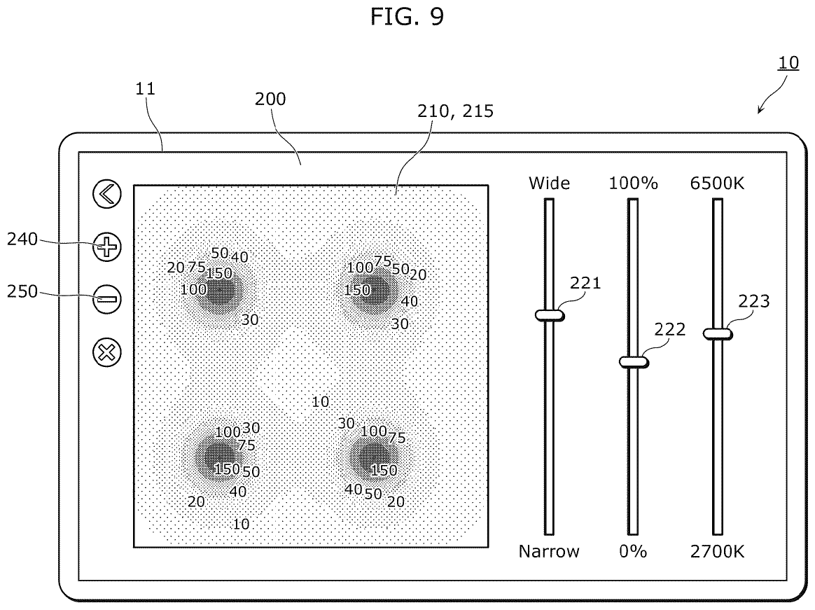

In operation screen 200 shown in FIG. 9, field 210 includes illuminance distribution image 215. Illuminance distribution image 215 is an image that represents an illuminance distribution that corresponds to an example of a brightness distribution in lighting space 100. Specifically, illuminance distribution image 215 represents illuminance at each position in lighting space 100. Illuminance distribution image 215 is generated based on an operation input from the user.

For example, when the user selects a position in field 210 and sets brightness (illuminance) for the selected position, an illuminance distribution is set in which the brightness (illuminance) decreases as it gets farther away from the selected position. When a plurality of positions are selected, an illuminance distribution is set in which the plurality of positions are local peaks in brightness (illuminance). For example, illuminance distribution image 215 shown in FIG. 9 shows an illuminance distribution when four positions have been selected.

The illuminance distribution is generated by, for example, acquirer 12 or controller 13, and displayed on the display. The illuminance distribution can be generated based on data of each fixture such as light distribution and luminous flux of each of lighting fixture group 30 and lighting fixtures 40 and 50. There is no particular limitation on the method for generating the illuminance distribution. Software for lighting design in a space or the like may be used. Also, for example, acquirer 12 may acquire an illuminance distribution generated by another device.

As described above, by visualizing and displaying the illuminance distribution, the lighting mode of lighting space 100 can be presented to the user simply viewing operation screen 200. With this configuration, more highly intuitive lighting control is possible.

Instead of illuminance distribution image 215, field 210 may include a color (color temperature) distribution image. The color distribution image represents color temperature at each position in lighting space 100. Illuminance distribution image 215 and the color distribution image may be automatically or manually switched and displayed.

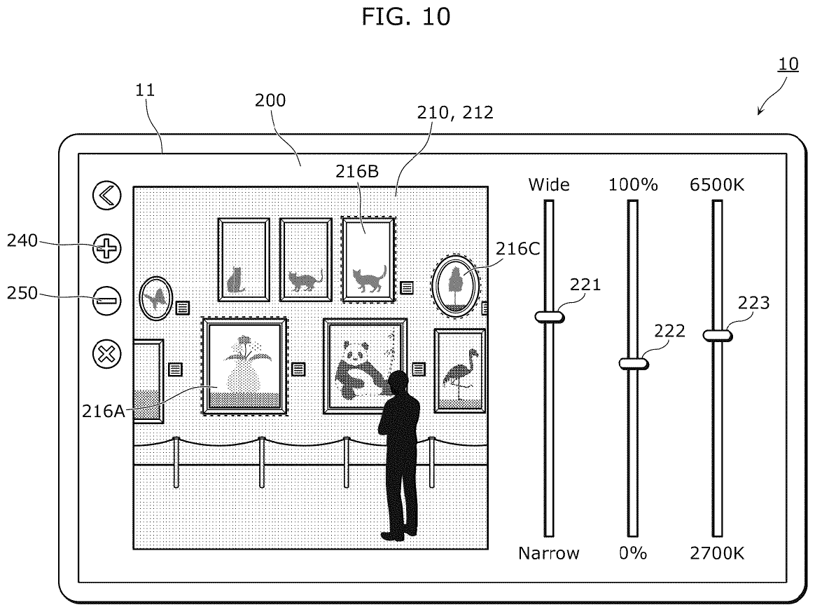

In operation screen 200 shown in FIG. 10, as in FIG. 6, field 210 includes, as a background image, captured image 212 obtained by capturing lighting space 100. Captured image 212 is an image captured using sensor 20.

Also, field 210 includes icons 216A, 216B, and 216C. Icons 216A, 216B, and 216C are displayed based on a result of detection performed by sensor 20. Specifically, icons 216A, 216B, and 216C that conform to the shapes of lighting target objects detected by sensor 20 are displayed. By the user selecting any one of icons 216A, 216B, or 216C, brightness adjustment, color adjustment, minor adjustment of shape and size, and the like of the corresponding lighting region can be performed.

In operation screen 200, when the user selects one position in captured image 212, an icon with a predetermined shape that corresponds to the selected position may be displayed. For example, when the user selects a portion of a painting, an icon with a shape that corresponds to the shape of the painting may be automatically displayed.

As described above, a region with a predetermined shape can be automatically illuminated, without the user having to perform an operation. By eliminating the need for the user to perform an operation, the level of user convenience can be further enhanced.

In the case where a result of detection performed by sensor 20 is used, terminal device 10 does not have to display operation screen 200. For example, controller 13 of terminal device 10 may determine a lighting region based on the result of detection, and determine the brightness and the color of the determined lighting region. For example, control information in which the type of lighting region (for example, a painting, a desk top surface, or the like), the size and/or the shape of the lighting region are associated in advance with the brightness and the color of the lighting region are associated may be stored in advance in controller 13. Controller 13 may perform lighting control based on the control information and the result of detection, without acquiring an operation input from the user.

Operation screens 200 shown in FIG. 4 and FIGS. 6 to 10 can be switched based on an operation performed by the user. For example, a display switch button may be provided on operation screen 200 such that, by selecting the display switch button, the content displayed in field 210 is changed.

Also, for example, a registration button for registering a set lighting mode (lighting scene) may be provided on operation screen 200. By registering a plurality of lighting modes, the lighting mode can be easily switched.

### Operation

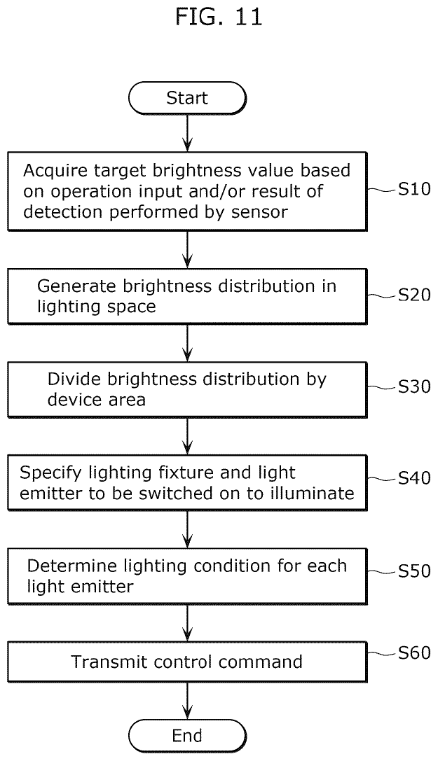

Next, an operation performed by lighting control system 1 according to the present embodiment will be described with reference to FIG. 11. FIG. 11 is a flowchart illustrating an operation performed by lighting control system 1 according to the present embodiment.

As shown in FIG. 11, first, acquirer 12 acquires target brightness value based on an operation input received by UI 11 and/or a result of detection performed by sensor 20 (S10). For example, by the user performing an operation on operation screen 200 displayed on the display of UI 11, UI 11 receives the operation input to operation screen 200. Acquirer 12 acquires, based on the operation input, a target value for the brightness at a predetermined position, and target values for the size, the shape, and the color of a lighting region that illuminates the predetermined position, and the like.

Next, controller 13 generates a brightness distribution in lighting space 100 based on the acquired information (S20). Specifically, controller 13 generates a brightness distribution in lighting space 100 based on the position of one or more icons in field 210 of operation screen 200 and the size, the shape, the brightness, and the color of each of the one or more icons.

Next, controller 13 divides the brightness distribution in lighting space 100 by area into area brightness distributions (S30). Specifically, controller 13 divides the brightness distribution in lighting space 100 into a brightness distribution in first area 110, a brightness distribution in second area 120, and a brightness distribution in third area 130. Controller 13 may further divide the brightness distribution in first area 110 by lighting area illuminated by each of lighting fixtures 31A to 31D.

Next, controller 13 specifies a lighting fixture and a light emitter to illuminate (S40). Lighting fixtures or light emitters may be associated with lightable regions in one-to-one correspondence with each other. For example, controller 13 specifies a light emitter or a lighting fixture that emits illumination light to a position that has a high illuminance in the brightness distribution, as the light emitter or a lighting fixture to be switched on to illuminate.

Next, controller 13 determines a lighting condition for each light emitter (S50). Specifically, controller 13 determines a lighting condition for each of lighting fixtures 31A to 31D based on the brightness distribution in first area 110. For example, controller 13 determines, as the lighting condition of each of lighting fixtures 31A to 31D, illumination intensity adjustment rate, color temperature, light irradiation range, and the like. Also, controller 13 determines an illumination intensity adjustment rate for each of the plurality of light emitting elements 42 of lighting fixture 40 as the lighting condition based on the brightness distribution in second area 120. Also, controller 13 determines the amount of adjustment, adjustment direction, and the like adjusted by adjuster 51 as the lighting condition based on the brightness distribution in third area 130. As described above, controller 13 determines lighting conditions suitable for lighting fixture group 30 and lighting fixtures 40 and 50 according to their ability.

At this time, in the case of illuminating adjacent lighting regions using two or more light emitters or lighting fixtures, controller 13 corrects the lighting conditions so as not to cause uneven lighting, a light scallop, a crack, and the like at a boundary portion between the adjacent lighting regions. For example, in the case where illumination light rays emitted from two light emitters or lighting fixtures partially overlap, the overlapping portion may have an excessively high level of illuminance. In this case, by changing the lighting condition of at least one of the two light emitters so as to reduce the illuminance of the overlapping portion, the illuminance of the overlapping portion can be reduced.

Next, controller 13 transmits a control command to each of lighting fixture group 30 and lighting fixtures 40 and 50 (S60). The control command includes the lighting condition generated for each of the lighting fixture groups and the lighting fixtures. Each of lighting fixture group 30 and lighting fixtures 40 and 50 emits illumination light based on the received control command. With this configuration, lighting space 100 is illuminated in a desired mode.

In the present embodiment, the processing shown in FIG. 11 is performed every time the user operates operation screen 200. As a result, the lighting mode of lighting space 100 can be changed in response to the user performing an input operation. It is only necessary for the user to operate operation screen 200, without the user having to be aware of the type of lighting fixture and the characteristics of lighting fixture. Accordingly, highly intuitive lighting control can be implemented.

### Conclusion

As described above, a lighting control system according to an A1st aspect of the present invention is, for example, lighting control system 1 described above, and includes: one or more lighting fixtures, each including one or more light emitters; controller 13 that controls the one or more light emitters; and acquirer 12 that acquires position information that indicates a predetermined position in lighting space 100 to be illuminated by the one or more lighting fixtures and a target brightness value of the predetermined position. The one or more light emitters emit illumination light rays that illuminate different regions in lighting space 100. Controller 13 determines a lighting condition for the one or more light emitters based on the target value acquired by acquirer 12, and controls the one or more light emitters based on the determined lighting condition.

With this configuration, the lighting condition is determined based on the target brightness value of the predetermined position, and thus the user does not need to specify a lighting fixture for illuminating the predetermined position. Lighting control can be performed without the user having to be aware of the presence of lighting fixtures, and thus the level of user convenience can be enhanced.

Also, a lighting control system according to an A2nd aspect of the present invention is the lighting control system according to the A1st aspect, wherein controller 13 specifies a light emitter to illuminate from among the one or more light emitters based on the predetermined position, and determines a lighting condition for the specified light emitter.

With this configuration, the lighting condition is determined based on the target brightness value of the predetermined position, and thus the user does not have to specify a lighting fixture for illuminating the predetermined position. Lighting control can be performed without the user having to be aware of the presence of lighting fixtures, and thus the level of user convenience can be enhanced.

Also, a lighting control system according to an A3rd aspect of the present invention is the lighting control system according to the A1st aspect or the A2nd aspect, wherein acquirer 12 further acquires a target value for at least one of a size, a shape, or a color of a lighting region for illuminating the predetermined position.

With this configuration, the lighting condition is determined based on not only brightness, but also color and the like. Accordingly, a lighting mode desired by the user can be formed in lighting space 100.

Also, a lighting control system according to an A4th aspect of the present invention is the lighting control system according to any one of the A1st to the A3rd aspects, wherein acquirer 12 acquires a plurality of target brightness values of a plurality of positions in lighting space 100 including the target brightness value of the predetermined position, and controller 13 generates a brightness distribution in lighting space 100 based on the plurality of target brightness values of the plurality of positions, and determines the lighting condition based on the generated brightness distribution.

With this configuration, the brightness in lighting space 100 can also be set more precisely. Accordingly, a lighting mode desired by the user can be formed in lighting space 100.

Also, a lighting control system according to an A5th aspect of the present invention is the lighting control system according to any one of the A1st to the A4th aspects, wherein the lighting control system includes UI 11 that receives an operation input from a user, and acquirer 12 acquires the target brightness value based on the operation input received by UI 11.

With this configuration, the user can set a desired lighting mode such as brightness using UI 11. At this time, a location and the brightness, color, and the like of the location desired by the user may be set without having to be aware of the presence of lighting fixtures. Accordingly, more highly intuitive lighting control is possible, and the level of user convenience can be further enhanced.

Also, a lighting control system according to an A6th aspect of the present invention is the lighting control system according to the A5th aspect, wherein UI 11 includes a display that displays field 210 defined in a two-dimensional coordinate system, and a set of two-dimensional coordinates in field 210 corresponds to a position in lighting space 100.

With this configuration, because field 210 and lighting space 100 are associated with each other, by selecting a position in field 210, it is possible to perform lighting control on a location that corresponds to the selected position. Accordingly, more highly intuitive lighting control is possible.

Also, a lighting control system according to an A7th aspect of the present invention is the lighting control system according to the A6th aspect, wherein field 210 includes, as a background image, a flat layout of lighting space 100 or a captured image of lighting space 100.

With this configuration, the flat layout or the captured image is included as the background image, and thus the user can easily envision actual lighting space 100. Accordingly, more highly intuitive lighting control is possible.

Also, a lighting control system according to an A8th aspect of the present invention is the lighting control system according to the A6th or the A7th aspect, wherein the display displays an icon in field 210 based on the operation input, and a set of two-dimensional coordinates that indicates a position of the icon in field 210 corresponds to the predetermined position.

With this configuration, by using the icon, the position to be subjected to lighting control can be displayed intuitively and clearly. Accordingly, highly intuitive lighting control is possible.

Also, a lighting control system according to an A9th aspect of the present invention is the lighting control system according to any one of the A1st to the A8th aspects, wherein the lighting control system includes sensor 20 that detects a predetermined lighting target object in lighting space 100, and acquirer 12 determines the predetermined position based on the lighting target object detected by sensor 20, and acquires the target brightness value of the determined predetermined position.

With this configuration, even when there is no operation input from the user, lighting control can be performed based on the result of detection performed by sensor 20. The number of operations the user has to perform is reduced, and thus the level of user convenience can be further enhanced.

Also, a lighting control system according to an A10th aspect of the present invention is the lighting control system according to any one of the A1st to the A9th aspects, wherein the one or more lighting fixtures include a plurality of lighting fixtures 31A to 31D, and the plurality of lighting fixtures 31A to 31D illuminate different regions.

With this configuration, it is possible to use the existing common lighting fixtures. Special lighting fixtures and the like are not required, and thus the lighting control system according to the present aspect can be easily introduced.

Also, a lighting control system according to an A11th aspect of the present invention is the lighting control system according to any one of the A1st to the A10th aspects, wherein the one or more lighting fixtures include lighting fixture 40, and lighting fixture 40 includes a plurality of light emitters.

With this configuration, using lighting fixture 40 alone, the lighting mode can be changed for each region. The number of lighting fixtures installed can be reduced, and thus the lighting control system according to the present aspect can be easily introduced.

Also, a lighting control system according to an A12th aspect of the present invention is the lighting control system according to any one of the A1st to the A11th aspects, wherein the one or more lighting fixtures include lighting fixture 50, and lighting fixture 50 includes adjuster 51 that adjusts a light emission direction of illumination light emitted from one or more light emitters 52.

With this configuration, using lighting fixture 50 alone, the lighting mode can be changed for each region. The number of lighting fixtures installed can be reduced, and thus the lighting control system according to the present aspect can be easily introduced.

Also, a terminal device according to an A13th aspect of the present invention is, for example, terminal device 10 described above, and includes: controller 13 that controls one or more light emitters included in one or more lighting fixtures; UI 11 that receives an operation input from a user; and acquirer 12 that acquires a target brightness value of a predetermined position in lighting space 100 to be illuminated by the one or more lighting fixtures based on the operation input received by UI 11. The one or more light emitters emit illumination light rays that illuminate different regions in lighting space 100. Controller 13 determines a lighting condition for the one or more light emitters based on the target value acquired by acquirer 12, and controls the one or more light emitters based on the determined lighting condition.

With this configuration, the lighting condition is determined based on the target brightness value of the predetermined position, and thus the user does not have to specify a lighting fixture for illuminating the predetermined position. Accordingly, lighting control can be performed without the user having to be aware of the presence of lighting fixtures, and thus the level of user convenience can be enhanced.

Also, a lighting control method according to an A14th aspect of the present invention includes the steps of: for example, controlling one or more light emitters included in one or more lighting fixtures; and acquiring a target brightness value of a predetermined position in lighting space 100 to be illuminated by the one or more lighting fixtures. The one or more light emitters emit illumination light rays that illuminate different regions in lighting space 100. The controlling step includes: determining a lighting condition for the one or more light emitters based on the acquired target value; and controlling the one or more light emitters based on the determined lighting condition.

With this configuration, the lighting condition is determined based on the target brightness value of the predetermined position, and thus the user does not have to specify a lighting fixture for illuminating the predetermined position. Lighting control can be performed without the user having to be aware of the presence of lighting fixtures, and thus the level of user convenience can be enhanced.

Also, a program according to an A15th aspect of the present invention is a program that causes a computer to execute the lighting control method according to the A14th aspect.

With this configuration, as with the lighting control method described above, the level of user convenience can be enhanced.

### Others

The lighting control system, the terminal device, the lighting control method, and the like according to the present invention have been described above based on the embodiment given above and the like. However, the present invention is not limited to the embodiment given above.

For example, lighting space 100 may include a plurality of rooms. For example, first area 110, second area 120, and third area 130 may be different rooms or areas separated by walls, partitions, or the like. Alternatively, lighting space 100 may be an outdoor space. In this case, lighting fixtures 31A to 31D, 40, and 50 may be fixed to poles or the like.

Also, for example, lighting fixtures 31A to 31D, 40, and 50 may each include a plurality of light emitters. In the case where each lighting fixture includes a plurality of light emitters, the plurality of light emitters do not necessarily need to be arranged in a two-dimensional array.

Also, for example, lighting control system 1 may include only one of lighting fixture group 30, lighting fixture 40, or lighting fixture 50. That is, lighting control system 1 does not necessarily need to include lighting fixture group 30. Lighting control system 1 does not necessarily need to include lighting fixture 40. Lighting control system 1 does not necessarily need to include lighting fixture 50. For example, in the case where lighting control system 1 includes lighting fixture 50, without including lighting fixture group 30 and lighting fixture 40, a plurality of regions can be illuminated by changing the light emission direction of the illumination light emitted from one light emitter 52.

Also, terminal device 10 does not necessarily need to include UI 11. In this case, acquirer 12 or controller 13 of terminal device 10 may automatically set a lighting region and a target brightness value based on a result of detection performed by sensor 20. For example, acquirer 12 or controller 13 may set a lighting region so as to illuminate only a lighting target object detected by sensor 20. Also, acquirer 12 or controller 13 may set the brightness and/or the color of the lighting region from the type of lighting target object detected by sensor 20 or the like based on a correspondence table in which the type of lighting target object or the position, the size and/or the shape of the lighting target object is associated with target values for brightness and/or color. The correspondence table is stored in a memory included in acquirer 12 or controller 13, or in a memory included in an external device such as a server that can be communicated with acquirer 12 or controller 13. With this configuration, even when UI 11 is not included in terminal device 10, automatic lighting control can be performed, and thus a lighting control system and the like with a high level of user convenience can be implemented.

Also, terminal device 10 may include sensor 20. For example, when the user captures an image of a lighting target object such as a painting in lighting space 100 by using sensor 20 of terminal device 10, the lighting target object is set as a lighting region, and the lighting region can be illuminated. It is unnecessary to provide sensor 20 that covers entire lighting space 100, and thus lighting control system 1 can be more easily introduced.

Also, for example, the lighting target object detected by sensor 20 may be a person, an animal such as a pet, or a mobile body such as an autonomous vacuum cleaner. For example, sensor 20 may detect a person's action. In lighting control system 1, when a person takes a predetermined action, the vicinity of the person can be automatically illuminated. For example, when sensor 20 detects a person who is moving into lighting space 100, position information regarding the position of the person is continuously transmitted to acquirer 12. Acquirer 12 and controller 13 control lighting fixture group 30 and the like so as to illuminate a range including the position indicated by the transmitted position information. With this configuration, the lighting region can be automatically changed to follow the movement of the person. The action detected by sensor 20 is not limited to a person's movement, and may be, for example, a person seating at a specific desk or on a specific chair or leaving from the desk or the chair, or the like. In this case, the following lighting control can be performed: when a person seating at a specific desk or on a specific chair is detected, the desk or the chair is illuminated; and when the person leaving from the desk or the chair is detected, the illumination on the desk or the chair is stopped.

Also, for example, wireless communication between (i) terminal device 10 and (ii) each of sensor 20, lighting fixture group 30, and lighting fixtures 40 and 50 may be performed using near-field communication such as ZigBee (registered trademark) or a wireless local area network (LAN). Alternatively, the wireless communication method (communication standard) may be communication via a wide area communication network such as the Internet. Also, instead of or in addition to wireless communication, wired communication may be performed between (i) terminal device 10 and (ii) each of sensor 20, lighting fixture group 30, and lighting fixtures 40 and 50. The wired communication may specifically be power line communication (PLC), communication using a wired LAN, or the like.

### Embodiment 2

### Overview

Next, Embodiment 2 will be described.

In the lighting device disclosed in PTL 3, a portion of light emitted from the light source is blocked by the light modulation element, and thus is not used as the illumination light. Accordingly, the lighting device disclosed in PTL 3 is problematic in that it has a low level of energy efficiency.

To address this, it is an object of the present embodiment to provide a lighting device, a lighting system, and a lighting device control method with which a high level of energy efficiency is achieved.

A lighting device according to one aspect of the present disclosure includes: a light source that includes a plurality of light emitting elements arranged in a two-dimensional array; a driving circuit that drives the light source; a projection lens that projects light emitted from the light source driven by the driving circuit as illumination light rays; and a signal processor that specifies one or more lighting target surfaces based on a signal output from a detection device whose detection range covers at least a portion of a projection range of the projection lens, wherein the driving circuit drives the light source to direct the illumination light to illuminate the one or more lighting target surfaces specified by the signal processor in the projection range of the projection lens. As the detection device, for example, an image sensor that includes a plurality of pixels arranged in a two-dimensional array, a ranging device, or the like can be used.

A lighting system according to one aspect of the present disclosure includes the lighting device according to one aspect of the present disclosure and the detection device described above.

A lighting device control method according to one aspect of the present disclosure includes the steps of: specifying one or more lighting target surfaces based on a signal output from a detection device whose detection range covers at least a portion of a projection range of a projection lens; and causing a driving circuit to drive a light source to direct illumination light to illuminate the one or more lighting target surfaces specified in the specifying step in the projection range of the projection lens.

Also, one aspect of the present invention can be implemented as a program that causes a computer to execute the lighting device control method described above. Alternatively, one aspect of the present invention can also be implemented as a computer-readable non-transitory recording medium in which the program is stored.

### Lighting System

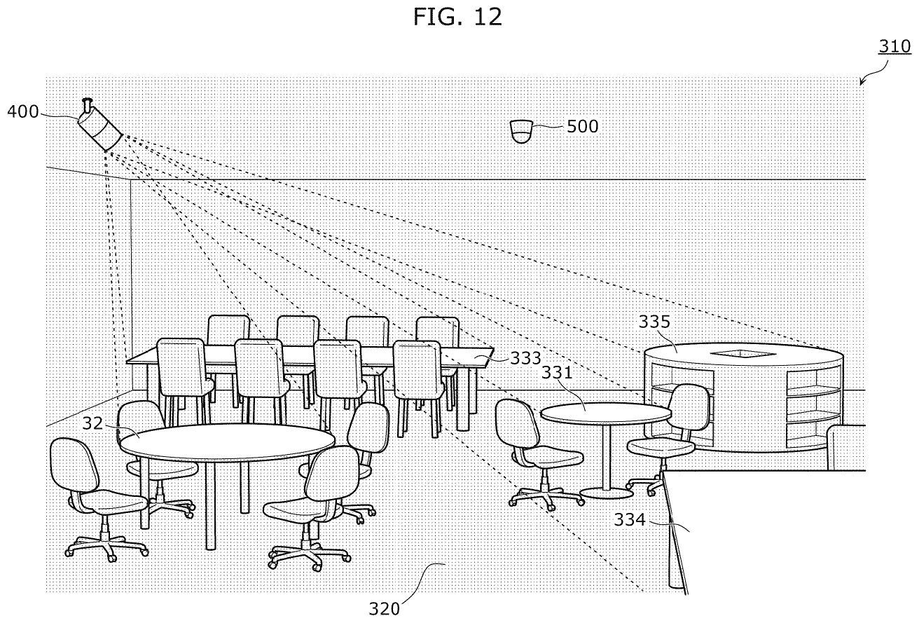

First, an overview of a lighting system according to Embodiment 2 will be described with reference to FIG. 12. FIG. 12 is a diagram showing a usage state of lighting system 310 according to the present embodiment.

As shown in FIG. 12, lighting system 310 includes lighting device 400 and ranging device 500. Lighting device 400 and ranging device 500 are provided at positions that are spaced apart from each other, and connected to be cable of performing communication with each other via a network.

Lighting device 400 illuminates a plurality of lighting target surfaces 331, 332, 333, 334, and 335 by projecting illumination light. Specifically, lighting device 400 can selectively illuminate only lighting target surfaces 331, 332, 333, 334, and 335 in an illumination light projection range. Lighting device 400 is fixed to, for example, the ceiling of a room, a wall near the ceiling, or the like.

Ranging device 500 generates an image by capturing the illumination light projection range. Based on the image generated by ranging device 500, lighting target surfaces 331, 332, 333, 334, and 335 are specified. Lighting target surfaces 331, 332, 333, 334, and 335 are surfaces that are parallel to floor surface 320 of a building or the ground. For example, lighting target surfaces 331, 332, 333, 334, and 335 are desk surfaces that can be used by people to do tasks such as working and studying. With lighting device 400 that illuminates lighting target surfaces 331, 332, 333, 334, and 335 that are desk surfaces, the task efficiency can be improved.

Ranging device 500 is fixed to, for example, the ceiling of the room, a wall near the ceiling, or the like. Ranging device 500 and lighting device 400 may be installed in close proximity to each other. The image capturing range of ranging device 500 covers at least a portion of the illumination light projection range of lighting device 400. In the present embodiment, an example will be described in which the image capturing range of ranging device 500 covers the entire illumination light projection range.

Although details will be described later, lighting device 400 according to the present embodiment includes a light source that includes a plurality of light emitting elements arranged in a two-dimensional array. Lighting device 400 can selectively illuminate only lighting target surfaces 331, 332, 333, 334, and 335 in the projection range by switching on only some of the plurality of light emitting elements to illuminate and switching off the remaining light emitting elements to extinct. It is possible to effectively use illumination light of light emitting elements that are switched on to illuminate, and switch off light emitting elements that are unnecessary to illuminate, and thus the level of energy efficiency can be enhanced.

### Lighting Device

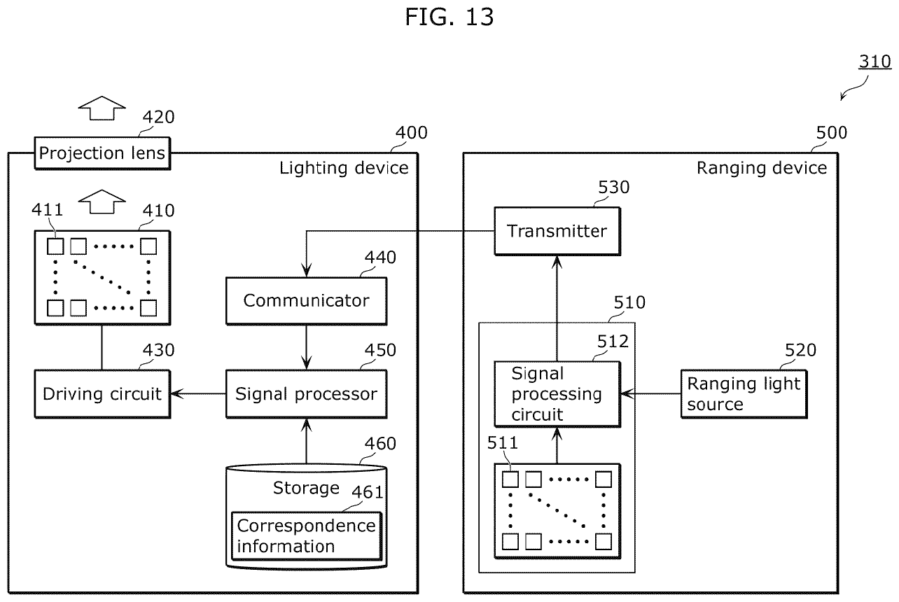

Next, a specific configuration of lighting device 400 according to the present embodiment will be described with reference to FIGS. 13 and 14, and also to FIG. 12 as appropriate.

FIG. 13 is a block diagram showing a configuration of lighting system 310 according to the present embodiment. FIG. 14 is a schematic perspective view of lighting device 400 according to the present embodiment.

As shown in FIG. 13, lighting device 400 includes light source 410, projection lens 420, driving circuit 430, communicator 440, signal processor 450, and storage 460. Also, as shown in FIG. 14, lighting device 400 includes casing 470. Lighting device 400 is, for example, one of a plurality of lighting fixtures included in lighting control system 1 according to Embodiment 1. Specifically, lighting device 400 corresponds to lighting fixture 40. More specifically, illumination circuit 41 of lighting fixture 40 corresponds to driving circuit 430. Array light source 43 of lighting fixture 40 corresponds to light source 410. The plurality of light emitting elements (light emitters) 42 correspond to a plurality of light emitting elements 411.

Light source 410 includes a plurality of light emitting elements 411 arranged in a two-dimensional array. Light source 410 is driven by driving circuit 430 and thereby emits light. Specifically, the plurality of light emitting elements 411 are controlled to be on to illuminate and off to extinct independently of each other by driving circuit 430. For example, driving circuit 430 can switch on only light emitting elements 411 required to illuminate lighting target surfaces 331, 332, 333, 334, and 335 to illuminate, and switch off light emitting elements 411 that are not required to illuminate lighting target surfaces 331, 332, 333, 334, and 335 to extinct. With this configuration, it is possible to reduce power consumption.

For example, by switching on all light emitting elements 411 included in a range with a predetermined shape to illuminate out of the plurality of light emitting elements 411 arranged in a two-dimensional array, illumination light for illuminating a region with the same shape is projected via projection lens 420. Also, for example, by switching on all light emitting elements 411 included in a plurality of ranges that do not overlap each other, illumination light can be projected from projection lens 420 to illuminate lighting target surfaces 331, 332, 333, 334, and 335 as shown in FIG. 12. That is, the outer shape of illumination range of a plurality of light emitting elements 411 in a two-dimensional array is the shape of lighting region illuminated by illumination light. When all of the plurality of light emitting elements 411 arranged in a two-dimensional array are switched on to illuminate, the lighting region is the illumination light projection range of projection lens 420. For example, the projection range is floor surface 320 shown in FIG. 12.

The plurality of light emitting elements 411 are μLEDs. As used herein, the term “μLED” refers to a micro LED with a size of 100 μm×100 μm or less.

The μLEDs emit light due to the electric current supplied from driving circuit 430. Each μLED includes a blue LED and a yellow phosphor provided on the light emission side of the blue LED. The yellow phosphor is excited by a portion of blue light emitted from the blue LED, and emits yellow light. The μLED emits white light as mixed light of blue light and yellow light.

The plurality of light emitting elements 411 are mounted on a substrate. The substrate is a rigid substrate, but may be a flexible substrate. A pattern wiring for electrically connecting each of the plurality of light emitting elements 411 to driving circuit 430 is formed on the substrate.

The plurality of light emitting elements 411 are arranged in a 256×256 array within a planar region of a predetermined size on the substrate. The planar region in which light emitting elements 411 are arranged is, for example, a 3 mm×3 mm rectangular region. The number of light emitting elements 411 and the size of region in which light emitting elements 411 are arranged are merely examples, and thus are not particularly limited thereto. By arranging the plurality of light emitting elements 411 in a small region, it is possible to achieve miniaturization of projection lens 420 or improve light intake efficiency.

Also, light source 410 has an illumination intensity adjustment function and an illumination color adjustment function. For example, each of the plurality of light emitting elements 411 can change the light emission intensity according to the amount of electric current supplied from driving circuit 430. Also, for example, the plurality of light emitting elements 411 may include a plurality of types of μLEDs that emit white light with different color temperatures. By adjusting the light emission intensity of the plurality of types of μLEDs, light source 410 can emit white light with a desired color temperature.

The plurality of light emitting elements 411 may include a red LED that emits red light, a green LED that emits green light, and a blue LED that emits blue light. With this configuration, light source 410 can also emit color lights other than white light.

Projection lens 420 projects light emitted from light source 410 driven by driving circuit 430 as illumination light. Projection lens 420 is composed of a plurality of lenses, but may be composed of only one lens.

Driving circuit 430 drives light source 410. Specifically, driving circuit 430 controls light illumination, light extinction, light emission intensity, and the like of each of the plurality of light emitting elements 411. Driving circuit 430 is implemented by, for example, an application-specific integrated circuit (ASIC). Driving circuit 430 supplies a pulse-width modulated (PWM) current to each of the plurality of light emitting elements 411. By adjusting the pulse width of the supplied current for each light emitting element 411, the light emission intensity of light emitting element 411 can be changed, and the illumination intensity adjustment function can be implemented. There is no particular limitation on the method for illumination intensity adjustment, and amplitude modulation, phase modulation, or the like can be used.

In the present embodiment, driving circuit 430 drives light source 410 to illuminate lighting target surfaces 331, 332, 333, 334, and 335 specified by signal processor 450. Specifically, driving circuit 430 specifies a plurality of light emitting elements 411 that correspond to lighting target surfaces 331, 332, 333, 334, and 335 based on correspondence information 461 stored in storage 460, and adjusts the electric current supplied to the specified plurality of light emitting elements 411.

Communicator 440 acquires an image captured by ranging device 500 by performing communication with ranging device 500. Communicator 440 performs wireless communication with ranging device 500. Specifically, communicator 440 performs communication with ranging device 500 via Bluetooth Low Energy (BLE (registered trademark)) or Wi-Fi (registered trademark). Communicator 440 is implemented by, for example, an antenna and a wireless processing circuit that processes a signal received by the antenna. Communicator 440 may perform wired communication with ranging device 500.

Signal processor 450 specifies, based on the image acquired from ranging device 500, a plurality of lighting target surfaces 331, 332, 333, 334, and 335. In the present embodiment, the image is a distance image that indicates distance for each pixel. Specifically, the distance image indicates, for each pixel, the distance from ranging device 500 to an object imaged on the pixel.

Signal processor 450 extracts, from the distance image, one or more surfaces that are parallel to floor surface 320 or the ground. For example, in the case where ranging device 500 is installed on the ceiling and the angle of view (image capturing range) is also fixed, floor surface 320 in the distance image can be estimated from the angle of view and the distance between the ceiling surface and floor surface 320. Accordingly, signal processor 450 can extract, based on the estimated floor surface 320, one or more surfaces that are parallel to floor surface 320 from the distance image. In the case where the installation position of ranging device 500 or the angle of view can be changed, processing is performed to estimate floor surface 320 in the changed distance image. The processing for estimating floor surface 320 may be performed by executing artificial intelligence (AI) processing on the distance image.

Signal processor 450 compares, for each of the extracted one or more surfaces, a height of the extracted surface from floor surface 320 or the ground with a first threshold value. Signal processor 450 specifies one or more surfaces that have a height greater than or equal to the first threshold value as one or more lighting target surfaces. The first threshold value is a predetermined lower limit value of height, and may be, for example, 60 cm. In general, it is said that the height of a work surface (desk surface) for working while sitting on a chair is 85 cm. For this reason, by setting the first threshold value to 60 cm, the desk surface can be specified as the one or more lighting target surfaces. It is also said that the height of a work surface (desk surface) for working while sitting on floor surface 320 in a Japanese style room or the like is usually 40 cm. For this reason, for example, by setting the first threshold value to 30 cm, the desk surface can be specified as the one or more lighting target surfaces. The specific value of the first threshold value may be changed as appropriate according to the type of space in which lighting device 400 is installed, or the like.

Signal processor 450 may compare, for each of the extracted one or more surfaces, a height of the extracted surface from floor surface 320 or the ground with a third threshold value. In this case, signal processor 450 specifies one or more surfaces that have a height greater than or equal to the first threshold value and less than or equal to the third threshold value as the one or more lighting target surfaces. The third threshold value is a predetermined upper limit value of height, and may be, for example, 150 cm. By setting the upper limit value of height, it is possible to reduce the possibility that a surface that is not used as a work surface such as the top surface of a bookshelf might be specified as the one or more lighting target surfaces. Signal processor 450 may specify one or more surfaces that have a height less than or equal to the third threshold value as the one or more lighting target surfaces, without performing comparison with the first threshold value.

Also, signal processor 450 compares, for each of the extracted one or more surfaces, an area of the extracted surface with a second threshold value. Signal processor 450 specifies one or more surfaces that have an area greater than or equal to the second threshold value as the one or more lighting target surfaces. The second threshold value is a predetermined lower limit value of area, and may be, for example, 2500 cm². However, the second threshold value is not limited thereto. Examples of a surface that has an area less than the second threshold value include the seat surface of a chair, a portion of an electric appliance, and the like, which are different from work surfaces. By excluding a surface that has such a small area from the one or more lighting target surfaces, energy saving can be achieved.

Signal processor 450 may compare, for each of the extracted one or more surfaces, an area of the extracted surface with a fourth threshold value. In this case, signal processor 450 specifies one or more surfaces that have an area greater than or equal to the second threshold value and less than or equal to the fourth threshold value as the one or more lighting target surfaces. The fourth threshold value is a predetermined upper limit value of area, and may be, for example, 10000 cm². By setting the upper limit value of area, it is possible to reduce the possibility that a surface that has a large area such as floor surface 320 might be specified as the one or more lighting target surfaces, even without performing comparison between height and threshold value. Signal processor 450 may specify one or more surfaces that have an area less than or equal to the fourth threshold value as the one or more lighting target surfaces, without performing comparison with the second threshold value.

In the present embodiment, signal processor 450 performs comparison, for each of the extracted one or more surfaces, in terms of both the height and the area of the extracted surface. Specifically, signal processor 450 specifies one or more surfaces that have a height greater than or equal to the first threshold value and an area greater than or equal to the second threshold value as the one or more lighting target surfaces. Alternatively, signal processor 450 may specify one or more surfaces that have a height greater than or equal to the first threshold value and less than or equal to the third threshold value and an area greater than or equal to the second threshold value and less than or equal to the fourth threshold value as the one or more lighting target surfaces.

As described above, signal processor 450 specifies one or more surfaces that have a height (or a height in a predetermined range) from floor surface 320 or the ground that is greater than or equal to a predetermined value and an area (or an area in a predetermined range) that is greater than or equal to a predetermined value as the one or more lighting target surfaces. With this configuration, it is possible to perform control to not illuminate a region other than the one or more lighting target surfaces while illuminating the one or more lighting target surfaces used as work surfaces such as desk surfaces. For example, as shown in FIG. 12, lighting device 400 can perform control to not illuminate floor surface 320 while illuminating lighting target surfaces 331, 332, 333, 334, and 335.

The one or more surfaces extracted by signal processor 450 are substantially flat surfaces. It is often the case that articles such as a monitor, a keyboard, a mouse, a writing tool, and a smartphone are placed on a desk surface. Signal processor 450 performs the area comparison by regarding the desk surface as a flat surface excluding the articles placed on the desk surface. With this configuration, signal processor 450 can specify the entire desk surface including the articles placed on the desk surface as the one or more lighting target surfaces, and thus the desk surface can be illuminated by lighting device 400.

Also, signal processor 450 may determine, for each of the extracted one or more surfaces, whether the extracted surface has an outer shape (outer edge shape) with a predetermined shape. The predetermined shape may be a shape such as a square, a rectangle, a circle, or an ellipse that is used as the shape of an ordinary desk surface. Signal processor 450 may specify the extracted one or more surfaces as the one or more lighting target surfaces when the outer shape of the extracted one or more surfaces has the predetermined shape. With this configuration, even when articles are placed on one or more surfaces, by using the outer shape of the one or more surfaces, the entire desk surface can be specified as the one or more lighting target surfaces.

Signal processor 450 specifies light emitting elements 411 to illuminate from among the plurality of light emitting elements 411 included in light source 410 based on the specified one or more lighting target surfaces. Specifically, signal processor 450 reads out correspondence information 461 stored in storage 460 from storage 460, and specifies light emitting elements 411 to illuminate using the read-out correspondence information 461.

Correspondence information 461 indicates a correspondence relationship between a plurality of light emitting elements 411 included in light source 410 and a plurality of pixels 511 included in image sensor 510. Specifically, pixels 511 and light emitting elements 411 are in a one-to-one, one-to-many, or many-to-one correspondence with each other.

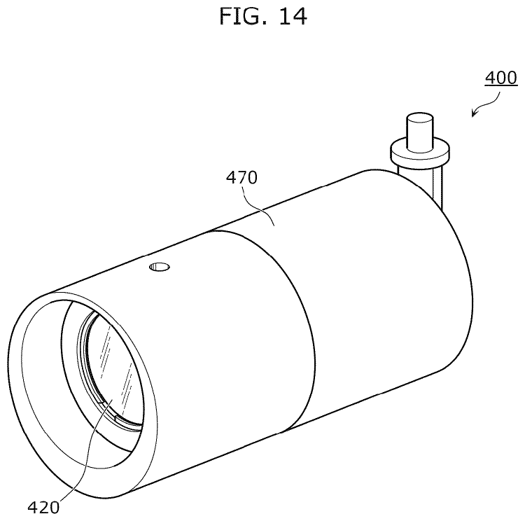

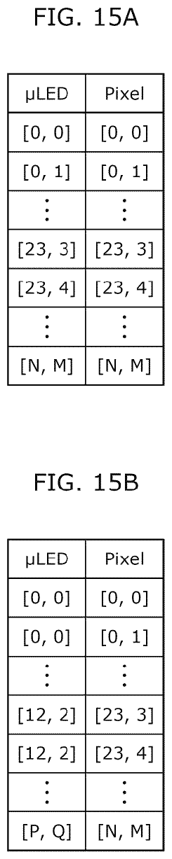

FIGS. 15A and 15B are diagrams showing examples of correspondence information 461 stored in storage 460 of lighting device 400 according to the present embodiment. Correspondence information 461 shown in FIG. 15A is an example in which light emitting elements 411 (μLEDs) and pixels 511 are associated in one-to-one correspondence. Correspondence information 461 shown in FIG. 15B is an example in which light emitting elements 411 (μLEDs) and pixels 511 are associated in a one-to-many correspondence. The correspondence relationships shown in FIGS. 15A and 15B are shown in the form of tables in which the positions of light emitting elements 411 and pixels 511 are defined by plane coordinates, but the configuration of correspondence information 461 is not limited thereto. There is no particular limitation on the information format as long as the correspondence relationship between light emitting elements 411 and pixels 511 is clearly shown.

When one or more light emitting elements 411 that correspond to one pixel 511 are illuminated, a region imaged on the one pixel 511 can be illuminated. Accordingly, by turning on one or more light emitting elements 411 that correspond to a plurality of pixels 511 included in the one or more lighting target surfaces specified by signal processor 450 to illuminate, the lighting target surfaces can be illuminated. Thus, signal processor 450 determines one or more light emitting elements 411 that correspond to a plurality of pixels 511 included in the specified one or more lighting target surfaces as light emitting elements 411 to illuminate.

Signal processor 450 transmits a signal to driving circuit 430 to turn on the determined light emitting elements 411 to illuminate. For example, signal processor 450 outputs, for each row of the plurality of light emitting elements 411, array data that includes data of light emission intensity of each light emitting element 411 expressed in an 8-bit format. Driving circuit 430 controls the plurality of light emitting elements 411 based on the array data output from signal processor 450.

Signal processor 450 is implemented by, for example, a large scale integration (LSI) that is an integrated circuit (IC). The integrated circuit is not limited to an LSI, and may be a dedicated circuit or a general-purpose processor. For example, signal processor 450 may be a microcontroller. Signal processor 450 includes, for example, a non-volatile memory in which a program is stored, a volatile memory that is a temporary storage area for executing a program, an input/output port, a processor for executing a program, and the like. Also, signal processor 450 may be a field programmable gate array (FPGA) that can be programmed or a reconfigurable processor that enables reconfiguration of the connection and setting of circuit cells in the LSI. The functions of signal processor 450 may be implemented by software or hardware.

Storage 460 Stores Correspondence Information 461. Storage 460 is, for example, a non-volatile storage device such as a hard disk drive (HDD) or a solid state drive (SSD).

Casing 470 houses light source 410, projection lens 420, driving circuit 430, communicator 440, signal processor 450, and storage 460. Casing 470 includes, for example, an outer contour casing that forms the outer contour of lighting device 400 and a plurality of components such as a heat sink. However, the configuration of casing 470 is not limited thereto. The components that constitute casing 470 are made using a resin or a metal. Communicator 440, signal processor 450, and storage 460 may be provided outside of casing 470. For example, signal processor 450 and storage 460 may be provided in a computer device, such as a server, that is connected to be capable of performing communication via communicator 440.

Casing 470 has an opening portion on the light emission side (in the normal direction of the main surface of the substrate) of light source 410, and projection lens 420 is disposed to close the opening portion. Unlike ordinary projectors, it is unnecessary to place a liquid crystal device or a digital mirror device (DMD) in casing 470, and thus the miniaturization of lighting device 400 can be achieved.

In the present embodiment, lighting device 400 is, for example, a spotlight, and is attached to wiring equipment (for example, a wiring duct or a hanging ceiling) provided on the ceiling or a wall. Lighting device 400 may be a downlight, a ceiling light, or the like.

As shown in FIG. 12, the illumination light projected from projection lens 420 of lighting device 400 configured as described above illuminates the plurality of lighting target surfaces 331, 332, 333, 334, and 335. At this time, out of the plurality of light emitting elements 411 included in light source 410, only some of the plurality of light emitting elements 411 are switched on to illuminate, and the remaining light emitting elements 411 are switched off to extinct. For example, circular lighting target surfaces 331, 332, and 335 and rectangular lighting target surfaces 333 and 334 can be illuminated by, out of the plurality of light emitting elements 411, switching on only light emitting elements 411 included in the circular ranges and the rectangular ranges that are spaced apart from each other to illuminate, and switching off the remaining light emitting elements 411 to extinct. That is, the position, the shape, and the size of a region (lighting region) to be illuminated by illumination light can be adjusted by adjusting the position, the shape, and the size of a range (illumination range) that includes light emitting elements 411 to illuminate out of the plurality of light emitting elements 411 included in light source 410. Also, the brightness and the color of the lighting region can adjusted by adjusting the light emission intensity of light emitting elements 411 included in the illumination range. Lighting target surface 335 has a rectangular opening at the center, and thus lighting device 400 does not have to emit illumination light to the opening. By precisely determining the shape of lighting target surface 335, it is possible to further contribute to energy saving.

As described above, with lighting device 400 according to the present embodiment, the plurality of lighting target surfaces 331, 332, 333, 334, and 335 can be illuminated using only one lighting device (lighting fixture). Also, by switching off light emitting elements 411 that are not required for illumination to extinct, the power consumption can be reduced.

Here, an example was described in which lighting target surfaces 331, 332, 333, 334, and 335 each have a rectangular or circular shape, but the shape of lighting target surfaces 331, 332, 333, 334, and 335 is not limited thereto. Lighting target surfaces 331, 332, 333, 334, and 335 may have a predetermined geometric shape such as a triangle, a polygon, or an ellipse.

### Ranging Device

Next, ranging device 500 according to the present embodiment will be described with reference to FIG. 13, and also to FIG. 12 as appropriate.

Ranging device 500 corresponds to an example of a detection device whose detection range covers at least a portion of the projection range of projection lens 420. As shown in FIG. 13, ranging device 500 includes image sensor 510, ranging light source 520, and transmitter 530. As shown in FIG. 12, ranging device 500 is fixed to, for example, the ceiling surface or a wall near the ceiling.

Image sensor 510 includes a plurality of pixels 511 arranged in a two-dimensional array and signal processing circuit 512. Image sensor 510 is a time-of-flight (ToF) distance image sensor or a stereo distance image sensor. In the case where image sensor 510 is a stereo distance image sensor, ranging device 500 does not necessarily need to include ranging light source 520.

Each of the plurality of pixels 511 is a photoelectric conversion element that has sensitivity in a range of wavelengths of distance measurement light (for example, an infrared wavelength range). The photoelectric conversion element is, for example, a photodiode, a phototransistor, or the like, but the photoelectric conversion element is not specifically limited thereto. Each of the plurality of pixels 511 outputs an electric signal that has a signal level according to the intensity of received light.

Signal processing circuit 512 generates a distance image based on the electric signal output from each of the plurality of pixels 511. Specifically, signal processing circuit 512 calculates a distance to an object that corresponds to each pixel 511 using ToF method based on the time at which ranging light source 520 emitted ranging light and the time at which each pixel 511 received reflected light of the ranging light. By doing so, signal processing circuit 512 can generate a distance image that includes distance information as pixel values of pixels 511. The distance image corresponds to an example of a signal output from the detection device, and an image that indicates a distance of each pixel from the detection device.

Ranging light source 520 is a light source that emits distance measurement light. The distance measurement light is, for example, infrared light. Ranging light source 520 is, for example, an LED or a laser element that emits infrared light, but is not limited thereto.

Transmitter 530 transmits the image generated by image sensor 510 to lighting device 400. Specifically, transmitter 530 performs communication with communicator 440 of lighting device 400 via BLE or Wi-Fi. Transmitter 530 is implemented by, for example, an antenna and a wireless processing circuit that processes a signal received by the antenna.

As described above, the distance image is used in the present embodiment, and thus the present embodiment is advantageous in terms of privacy protection.

### Operation

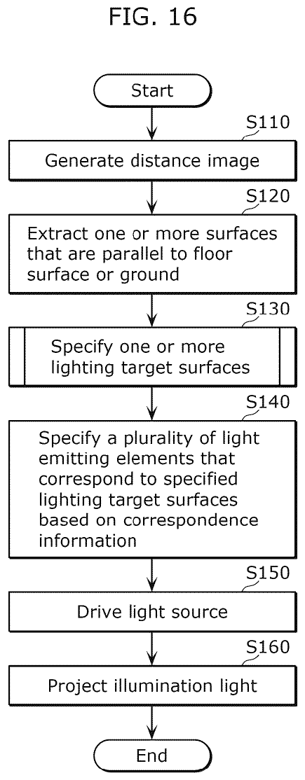

Next, an operation performed by lighting system 310 according to the present embodiment will be described with reference to FIG. 16.

FIG. 16 is a flowchart illustrating an operation performed by lighting system 310 according to the present embodiment.

As shown in FIG. 16, first, image sensor 510 of ranging device 500 generates a distance image (S110). Specifically, ranging light source 520 emits ranging light, and image sensor 510 receives reflected light of the ranging light. Signal processing circuit 512 generates a distance image by calculating a distance for each pixel 511 using ToF method. The generated distance image is transmitted by transmitter 530, and is acquired by communicator 440 of lighting device 400.

Next, signal processor 450 of lighting device 400 extracts, from the distance image, one or more surfaces that are parallel to floor surface 320 or the ground (S120). Next, signal processor 450 specifies one or more lighting target surfaces from among the extracted one or more surfaces (S130).

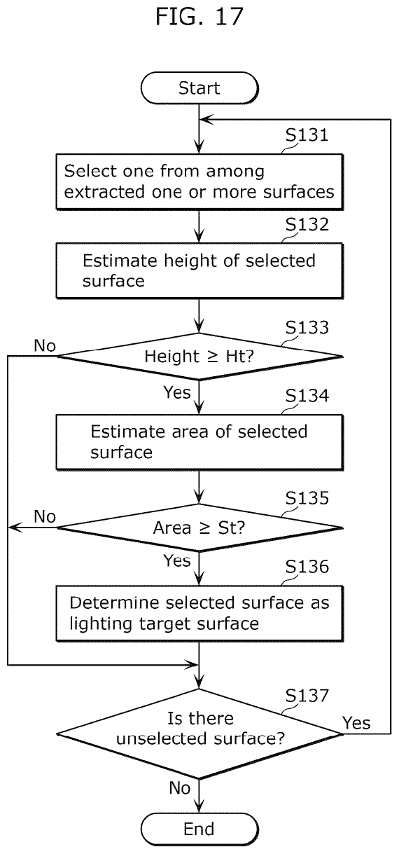

FIG. 17 is a flowchart illustrating lighting target surface specifying processing included in the operation performed by lighting system 310 according to the present embodiment. As shown in FIG. 17, first, signal processor 450 selects one from among the extracted one or more surfaces (S131). Next, signal processor 450 estimates a height of the selected surface (S132). Specifically, signal processor 450 calculates a distance from floor surface 320 based on the distance information of each pixel 511 that constitutes the selected surface.

Next, signal processor 450 compares the height of the selected surface with threshold value Ht (S133). Threshold value Ht corresponds to an example of a first threshold value. When the height of the selected surface is less than threshold value Ht (No in S133), signal processor 450 determines that the selected surface is not a lighting target surface, and the procedure proceeds to step S137.

When the height of the selected surface is greater than or equal to threshold value Ht (Yes in S133), signal processor 450 estimates an area of the selected surface (S134). Specifically, signal processor 450 calculates an area of the selected surface based on the number of pixels 511 included in the selected surface, the angle of view of ranging device 500, and the like.

Next, signal processor 450 compares the area of the selected surface with threshold value St (S135). Threshold value St corresponds to an example of a second threshold value. When the area of the selected surface is less than threshold value St (No in S135), signal processor 450 determines that the selected surface is not a lighting target surface, and the procedure proceeds to step S137.

When the area of the selected surface is greater than or equal to threshold value St (Yes in S135), signal processor 450 determines the selected surface as the one or more lighting target surfaces (S136). Through the determination processing performed in steps S133 and S135, signal processor 450 can specify one or more surfaces that have a height from floor surface 320 or the ground greater than or equal to threshold value Ht and an area greater than or equal to threshold value St as the one or more lighting target surfaces.

The steps of estimating and comparing the area (S134 and S135) may be performed prior to the steps of estimating and comparing the height (S132 and S133). Also, as described above, the comparison may be performed using at least one of the upper limit value of height or the upper limit value of area.

Next, signal processor 450 determines whether there is an unselected surface that has not been selected in step S131 among the extracted one or more surfaces (S137). If it is determined that there is an unselected surface (Yes in S137), the procedure returns to step S131, and the above-described processing is repeated. If it is determined that all of the extracted one or more surfaces have been processed (No in S137), the procedure proceeds to step S140 shown in FIG. 16.

Returning to FIG. 16, after the one or more lighting target surfaces have been specified, signal processor 450 specifies a plurality of light emitting elements 411 that correspond to the one or more lighting target surfaces based on correspondence information 461 (S140).

Next, driving circuit 430 drives light source 410 (S150). Specifically, driving circuit 430 supplies a desired electric current to light emitting elements 411 to illuminate out of the plurality of light emitting elements 411 so as to illuminate only the lighting target surfaces specified by signal processor 450. No electric current is supplied to light emitting elements 411 that are unnecessary to be switched on to illuminate.

Next, projection lens 420 projects the light from light emitting elements 411 illuminated by the supply of electric current as illumination light (S160). By doing so, lighting device 400 can illuminate a region that has the same shape as the outer shape of the illumination range in the two-dimensional array.

The above-described operation is merely an example, and thus changes may be made such as changing the order of steps.

### Variation

Next, a description will be given of variations of lighting system 310 and lighting device 400 described above. The following description will be given focusing mainly on differences from the embodiment described above, and a description of the same components is omitted or simplified.

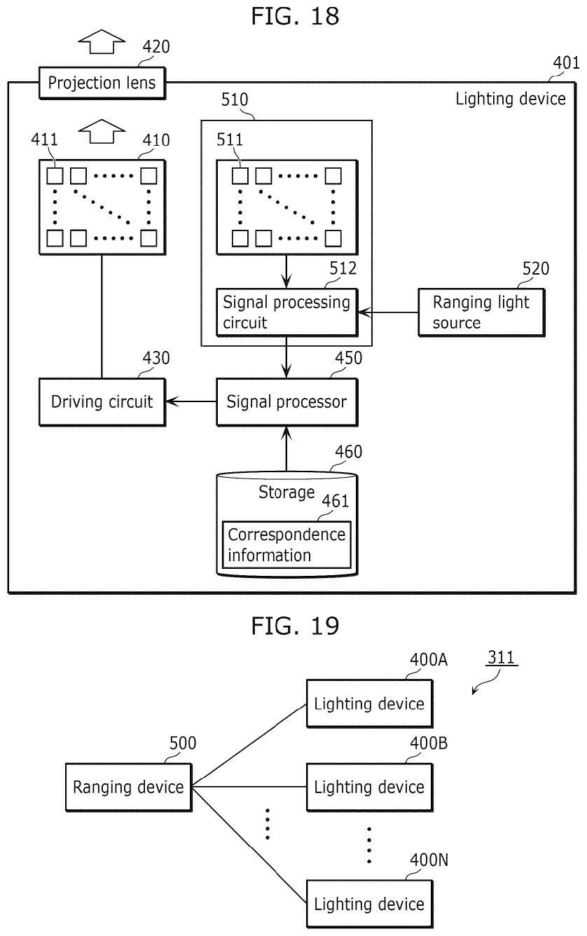

FIG. 18 is a block diagram showing a configuration of lighting device 401 according to Variation 1. As shown in FIG. 18, lighting device 401 is different from lighting device 400 shown in FIG. 13 in that lighting device 401 includes, instead of communicator 440, image sensor 510 and ranging light source 520. That is, lighting device 401 has an integrated configuration of lighting device 400 and ranging device 500 shown in FIG. 13, which are housed in one casing 470.

With this configuration, the relationship between the image capturing range of ranging device 500 and the projection range of lighting device 400 can be easily fixed, and thus the correspondence relationship between the plurality of pixels 511 and the plurality of light emitting elements 411 can be easily fixed. Accordingly, the specified lighting target surfaces can be illuminated with illumination light with high accuracy.

FIG. 19 is a block diagram showing a configuration of lighting system 311 according to Variation 2. As shown in FIG. 19, lighting system 311 includes one ranging device 500 and a plurality of lighting devices 400A to 400N. Each of lighting devices 400A to 400N has the same configuration as that of lighting device 400 according to Embodiment 2.

That is, in lighting system 311 according to the present variation, a distance image generated by one ranging device 500 is shared and used by the plurality of lighting devices 400A to 400N. The present variation is useful when, for example, the distance image generated by ranging device 500 has a large image capturing range, whereas the projection ranges of lighting devices 400A to 400N are small. There is no need to provide a ranging device for each lighting device, and thus lighting system 311 with a simplified configuration can be achieved.

### Conclusion

As described above, a lighting device according to a B1st aspect of the present invention is, for example, lighting device 400 or 401 described above, and includes: light source 410 that includes a plurality of light emitting elements 411 arranged in a two-dimensional array; driving circuit 430 that drives light source 410; projection lens 420 that projects light emitted from light source 410 driven by driving circuit 430 as illumination light; and signal processor 450 that specifies one or more lighting target surfaces based on a signal output from a detection device whose detection range covers at least a portion of a projection range of projection lens 420. Driving circuit 430 drives light source 410 to direct the illumination light to illuminate the one or more lighting target surfaces specified by signal processor 450 in the projection range of projection lens 420. For example, the detection device includes image sensor 510 that includes a plurality of pixels 511 arranged in a two-dimensional array. Signal processor 450 specifies one or more lighting target surfaces from an image generated by image sensor 510.

For example, ordinary projectors can provide illumination in predetermined patterns (can illuminate differently for each region) by blocking a portion of light from the light source by using a liquid crystal device or a DMD. However, the blocked light is not used for illumination, which means a portion of energy is wasted. In contrast, with the lighting device according to the present aspect, out of the plurality of light emitting elements 411, light emitting elements 411 that are not required to illuminate the lighting target surfaces can be switched off to extinct. With this configuration, a lighting device with a high level of energy efficiency can be achieved.

Also, with the lighting device according to the present aspect, the lighting target surfaces can be specified automatically. Accordingly, for example, even when the layout of the room is changed such as moving a desk, the desk surface of the moved desk can be illuminated. The need to manually set lighting target surfaces is eliminated, and thus even in the case where there are many lighting target surfaces or where the lighting target surfaces have a complicated shape, it is possible to easily illuminate the lighting target surfaces, and thus the level of user convenience can be enhanced.

Also, for example, a lighting device according to according to a B2nd aspect of the present invention lighting device is the lighting device according to the B1st aspect, wherein the detection device generates a distance image whose pixels each indicate a distance from the detection device in the form of a signal. For example, image sensor 510 generates a distance image that indicates the distance from the detection device for each pixel 511.

With this configuration, for example, a distance image sensor that uses infrared light can be used as image sensor 510. The distance image sensor does not generate images based on visible light such as color images or black and white images, and thus privacy can be protected.

Also, for example, a lighting device according to a B3rd aspect of the present invention is the lighting device according to the B1st aspect or the B2nd aspect, wherein the lighting device includes storage 460 that stores correspondence information 461 that indicates a correspondence relationship between the plurality of light emitting elements 411 and the plurality of pixels 511.

With this configuration, by using correspondence information 461, it is possible to easily determine light emitting elements 411 to be switched on to illuminate. The illumination control of light emitting elements 411 can be easily performed, and thus a lighting device with excellent responsivity can be implemented.

Also, for example, a lighting device according to a B4th aspect of the present invention is the light device according to any one of the B1th to the B3rd aspects, wherein the one or more lighting target surfaces are surfaces that are parallel to floor surface 320 or the ground.

With this configuration, it is possible to illuminate work surfaces such as desk surfaces as the lighting target surfaces. By illuminating the work surfaces, the task efficiency can be enhanced.

Also, for example, a lighting device according to a B5th aspect of the present invention is the lighting device according to the B4th aspect, wherein signal processor 450 extracts one or more surfaces that are parallel to floor surface 320 or the ground from the distance image whose pixels each indicate the distance from the detection device and compares, for each of the extracted one or more surfaces, a height from floor surface 320 or the ground with a first threshold value to specify one or more surfaces that have a height greater than or equal to the first threshold value as the one or more lighting target surfaces.

With this configuration, surfaces other than desk surfaces are unlikely to be specified as the lighting target surfaces, and it is therefore possible to prevent the illumination light from being projected to surfaces unnecessary to illuminate, and thus the level of energy efficiency can be enhanced.

Also, for example, a lighting device according to a B6th aspect of the present invention is the lighting device according to the B5th aspect, wherein signal processor 450 further compares, for each of the extracted one or more surfaces, an area of the extracted surface with a second threshold value, and specifies one or more surfaces that have a height greater than or equal to the first threshold value and an area greater than or equal to the second threshold value as the one or more lighting target surfaces.

With this configuration, surfaces other than desk surfaces are more unlikely to be specified as the lighting target surfaces, and thus the energy efficiency can be further enhanced.

Also, for example, a lighting device according to a B7th aspect of the present invention is the light device according to any one of the B1th to the B6th aspects, wherein the plurality of light emitting elements 411 are μLEDs.

With this configuration, the miniaturization of light source 410 can be achieved, and thus the miniaturization of the entire device can also be achieved.

Also, for example, a lighting system according to a B8th aspect of the present invention is, for example, lighting system 310 described above, and includes the light device according to any one of the B1th to the B7th aspects and a detection device. For example, the lighting system according to the present aspect includes image sensor 510 as the detection device.

With this configuration, as with lighting device 400 described above, a lighting system with a high level of energy efficiency can be achieved.

Also, for example, a lighting device control method according to a B9th aspect of the present invention includes the steps of: specifying one or more lighting target surfaces based on a signal output from a detection device whose detection range covers at least a portion of a projection range of projection lens 420; and causing driving circuit 430 to drive light source 410 to direct illumination light to illuminate the one or more lighting target surfaces specified in the specifying step in the projection range of projection lens 420. For example, in the step of specifying the one or more lighting target surfaces, the one or more lighting target surfaces are specified from an image generated by image sensor 510 that includes a plurality of pixels 511 arranged in a two-dimensional array.

With this configuration, as with lighting device 400 described above, it is possible to provide a lighting device control method with which a high level of energy efficiency is achieved.

### Others

Up to here, the lighting device, the lighting system, and the lighting device control method according to the present invention have been described based on the embodiment given above and the like. However, the present invention is not limited to the embodiment given above.

For example, in the embodiment given above, an example was described in which light emitting elements 411 are μLEDs, but light emitting elements 411 are not limited thereto. Light emitting elements 411 may be ordinary size LEDs, organic EL elements, or laser elements.

Also, for example, light source 410 may have only either one of the illumination intensity adjustment function or the illumination color adjustment function. For example, the plurality of light emitting elements 411 can only be controlled to be switched on to illuminate and off to extinct, and the light emission intensity during illumination may always be set to a constant value.

For example, in the embodiment given above, an example was described in which the image generated by image sensor 510 is a distance image, but the image generated by image sensor 510 is not limited thereto. The image may be an ordinary color image or an ordinary black and white image whose pixel values each indicate the intensity of incident light. In this case, signal processor 450 may estimate the distance to the object imaged on each pixel by executing artificial intelligence (AI) processing on the color image or the black and white image. An ordinary visible light image sensor can be used as image sensor 510, and thus lighting system 310 can be constructed at low cost. Alternatively, the existing equipment such as a surveillance camera can be used as ranging device 500.

Also, an example was described in which ranging device 500 that includes image sensor 510 is used as the detection device, but the configuration is not limited thereto. For example, a device that uses means other than visible light may also be used as the detection device. For example, the detection device may be a light detection and ranging (LiDAR) sensor, an ultrasonic sensor, a radio wave sensor, or a composite sensor obtained by combining a plurality of sensors from among the above-listed sensors. These sensors are more useful in terms of privacy protection.

Also, for example, the lighting target surfaces to be illuminated do not necessarily need to be surfaces that are parallel to the floor surface or the ground as long as the lighting target surfaces are surfaces that satisfy a preset condition for specifying as lighting targets. For example, the lighting target surfaces may be surfaces that are perpendicular to the floor surface or the ground, and may specifically be wall surfaces or pillar surfaces. Alternatively, the lighting target surfaces may be a portion of the floor surface or the ground, or a portion of the ceiling surface.

For example, lighting system 310 and lighting device 400 may illuminate exhibited items and the like instead of work surfaces. For example, lighting device 400 may specify an area including a painting on the wall as the lighting target surface, and illuminate the specified area.

Also, for example, lighting system 310 may include a plurality of ranging devices 500. The image capturing ranges of the plurality of ranging devices 500 may partially overlap each other, but at least partially do not overlap each other. The entire image capturing range (including individual image capturing ranges) of the plurality of ranging devices 500 as a whole covers the projection range of one lighting device 400 or the projection ranges of a plurality of lighting devices 400A to 400N.

Also, in the embodiment given above, a processing operation performed by a specific processor may be performed by a different processor. Also, the order of a plurality of processing operations may be changed, or a plurality of processing operations may be performed in parallel. Also, the assignment of the structural elements of lighting control system 1 or lighting system 310 to a plurality of devices is merely an example. For example, the structural elements of one device may be included in a different device.

For example, the processing operations described in the embodiment given above may be performed through centralized processing using a single device (system) or distributed processing using a plurality of devices. Also, the number of processors for executing the program may be one or more. That is, centralized processing may be performed, or distributed processing may be performed.

Also, in the embodiment given above, all or some of the structural elements of the controller or the like may be implemented using dedicated hardware or may be implemented by executing a software program suitable for the structural elements. The structural elements may be implemented by a program executor such as a central processing unit (CPU) or a processor reading and executing a software program recorded in a recording medium such as a hard disk drive (HDD) or a semiconductor memory.

Also, the structural elements of the controller or the like may be composed of one or more electronic circuits. The one or more electronic circuits may be general-purpose circuits or dedicated circuits.

The one or more electronic circuits may include, for example, semiconductor devices, ICs, LSIs, or the like. The ICs or LSIs may be integrated on a single chip or a plurality of chips. Here, they are called ICs or LSIs, but may be called by different names depending on the degree of integration such as system LSI, very large scale integration (VLSI), or ultra large scale integration (ULSI). Also, an FPGA programmed after the production of LSIs may also be used for the same purpose.

Also, generic or specific aspects of the present invention may be implemented by a system, a device, a method, an integrated circuit, or a computer program. Alternatively, the aspects of the present invention may also be implemented by a computer-readable non-transitory recording medium, such as an optical disk, a HDD, or a semiconductor memory, in which the computer program is stored. The aspects of the present invention may also be implemented by any combination of a system, a device, a method, an integrated circuit, a computer program, and a recording medium.

The present invention also encompasses other embodiments obtained by making various modifications that can be conceived by a person having ordinary skill in the art to the above-described embodiment as well as embodiments implemented by any combination of the structural elements and the functions of the above-described embodiment without departing from the scope of the present disclosure.

### REFERENCE SIGNS LIST

1 lighting control system
10 terminal device
11 UI
12 acquirer
13 controller
20 sensor
30 lighting fixture group
31A, 31B, 31C, 31D, 40, 50 lighting fixture
32A, 32B, 32C, 32D, 52 light emitter
41 illumination circuit
42 light emitting element (light emitter)
42A, 42B, 42C illuminating light emitting element
43 array light source
51 adjuster
90 operating element
100 lighting space
110 first area
120 second area
121A, 121B, 121C lighting region
130 third area
200 operation screen
210 field
211A, 211B, 211C, 214A, 214B, 214C, 216A, 216B, 216C icon
212 captured image
213 layout image
215 illuminance distribution image
221 size adjustment object
222 brightness adjustment object
223 color adjustment object
240 add button
250 remove button
310, 311 lighting system
320 floor surface
331, 332, 333, 334, 335 lighting target surface
400, 401 lighting device
410 light source
411 light emitting element
420 projection lens
430 driving circuit
450 signal processor
460 storage
461 correspondence information
500 ranging device
510 image sensor
511 pixel

1. A lighting control system comprising:
one or more lighting fixtures, each including one or more light emitters;
a controller that controls the one or more light emitters; and
an acquirer that acquires position information that indicates a predetermined position in a space to be illuminated by the one or more lighting fixtures and a target brightness value of the predetermined position,
wherein the one or more light emitters emit illumination light rays that illuminate different regions in the space, and
the controller determines, based on the target brightness value acquired by the acquirer, a lighting condition for the one or more light emitters, and controls the one or more light emitters based on the lighting condition determined.

2. The lighting control system according to claim 1,
wherein the controller specifies a light emitter to illuminate from among the one or more light emitters based on the predetermined position, and determines a lighting condition for the light emitter specified.

3. The lighting control system according to claim 2,
wherein the acquirer further acquires a target value for at least one of a size, a shape, or a color of a lighting region for illuminating the predetermined position.

4. The lighting control system according to claim 1,
wherein the acquirer acquires a plurality of target brightness values of a plurality of positions in the space including the target brightness value of the predetermined position, and
the controller generates a brightness distribution in the space based on the plurality of target brightness values of the plurality of positions, and determines the lighting condition based on the brightness distribution generated.

5. The lighting control system according to claim 1, further comprising:
a user interface that receives an operation input from a user,
wherein the acquirer acquires the target brightness value based on the operation input received by the user interface.

6. The lighting control system according to claim 5,
wherein the user interface includes a display that displays a field defined in a two-dimensional coordinate system, and
a set of two-dimensional coordinates in the field corresponds to a position in the space.

7. The lighting control system according to claim 6,
wherein the field includes, as a background image, an image that shows a flat layout of the space or a captured image of the space.

8. The lighting control system according to claim 6,
wherein the display displays an icon in the field based on the operation input, and
a set of two-dimensional coordinates that indicates a position of the icon in the field corresponds to the predetermined position.

9. The lighting control system according to claim 1, further comprising:
a sensor that detects a predetermined lighting target object in the space,
wherein the acquirer determines the predetermined position based on the lighting target object detected by the sensor, and acquires the target brightness value of the predetermined position determined.

10. The lighting control system according to claim 1,
wherein the one or more lighting fixtures include a plurality of first lighting fixtures, and
the plurality of first lighting fixtures illuminate different regions.

11. The lighting control system according to claim 1,
wherein the one or more lighting fixtures include a second lighting fixture, and
the second lighting fixture includes a plurality of light emitters out of the one or more light emitters.

12. The lighting control system according to claim 1,
wherein the one or more lighting fixtures include a third lighting fixture, and
the third lighting fixture includes an adjuster that adjusts a light emission direction of illumination light emitted from the one or more light emitters.

13. The lighting control system according to claim 1,
wherein at least one of the one or more lighting fixtures includes:
a light source that includes a plurality of light emitters out of the one or more light emitters;
a driving circuit that drives the light source;
a projection lens that projects light emitted from the light source driven by the driving circuit as the illumination light rays; and
a signal processor that specifies one or more lighting target surfaces based on a signal output from a detection device whose detection range covers at least a portion of a projection range of the projection lens,
the plurality of light emitters are a plurality of light emitting elements arranged in a two-dimensional array, and
the driving circuit drives the light source to direct the illumination light to illuminate the one or more lighting target surfaces specified by the signal processor in the projection range of the projection lens.

14. The lighting control system according to claim 13,
wherein the detection device outputs, as the signal, a distance image whose pixels each indicate a distance from the detection device.

15. The lighting control system according to claim 14, further comprising:
a storage that stores correspondence information that indicates a correspondence relationship between the plurality of light emitting elements and the pixels of the distance image.

16. The lighting control system according to claim 13,
wherein the one or more lighting target surfaces are one or more surfaces that are parallel to a floor surface or a ground.

17. The lighting control system according to claim 16,
wherein the signal processor extracts the one or more surfaces that are parallel to the floor surface or the ground from the distance image whose pixels each indicate a distance from the detection device, and compares, for each of the one or more surfaces extracted, a height from the floor surface or the ground with a first threshold value to specify one or more surfaces that have a height greater than or equal to the first threshold value as the one or more lighting target surfaces.

18. The lighting control system according to claim 17,
wherein the signal processor further compares, for each of the one or more surfaces extracted, an area with a second threshold value, and specifies one or more surfaces that have a height greater than or equal to the first threshold value and an area greater than or equal to the second threshold value as the one or more lighting target surfaces.

19. The lighting control system according to claim 13,
wherein the plurality of light emitting elements are micro light emitting diodes (μLEDs).

20. A terminal device comprising:
a controller that controls one or more light emitters included in one or more lighting fixtures;
a user interface that receives an operation input from a user; and
an acquirer that acquires position information that indicates a predetermined position in a space to be illuminated by the one or more lighting fixtures based on the operation input received by the user interface and a target brightness value of the predetermined position,
wherein the one or more light emitters emit illumination light rays that illuminate different regions in the space, and
the controller determines a lighting condition for the one or more light emitters based on the target brightness value acquired by the acquirer, and controls the one or more light emitters based on the lighting condition determined.

21. A lighting control method comprising:
controlling one or more light emitters included in one or more lighting fixtures; and
acquiring position information that indicates a predetermined position in a space to be illuminated by the one or more lighting fixtures and a target brightness value of the predetermined position,
wherein the one or more light emitters emit illumination light rays that illuminate different regions in the space, and
the controlling includes: determining a lighting condition for the one or more light emitters based on the target brightness value acquired; and controlling the one or more light emitters based on the lighting condition determined.

22. A non-transitory computer-readable recording medium having recorded thereon a program for causing a computer to execute the lighting control method according to claim 21.
